(19) United States
(12) Patent Application Publication
(10) Pub. No.: US 2013/0058416 A1
(43) Pub. Date: Mar. 7, 2013

(54) IMAGE PROCESSING APPARATUS AND METHOD

(71) Applicants: Toshiharu Tsuchiya, Kanagawa (JP); Toru Wada, Kanagawa (JP)

(72) Inventors: Toshiharu Tsuchiya, Kanagawa (JP); Toru Wada, Kanagawa (JP)

(73) Assignee: SONY CORPORATION, Tokyo (JP)

(21) Appl. No.: 13/696,846

(22) PCT Filed: Apr. 25, 2011
(86) PCT No.: PCT/JP2011/060015

§ 371 Date: Nov. 8, 2012

(30) Foreign Application Priority Data
May 18, 2010 (JP) 2010-114577

(51) Int. Cl. H04N 7/36

(52) U.S. Cl. 375/240.16; 375/240.26; 375/E07.256

(57) ABSTRACT

An image processing apparatus and an image processing method capable of further improving coding efficiency while suppressing an increase in a load. For example, in a case a macro block with a size of 16×16 pixels or less used in AVC is a coding process target, a motion search and compensation unit performs a motion search using an image with the original size which is not reduced. In addition, for example, in a case where an extended macro block with a size larger than 16×16 pixels is a coding process target, the motion search and compensation unit performs a motion search using a reduced image.

### TECHNICAL FIELD

The present invention relates to an image processing apparatus and an image processing method, and more particularly to an image processing apparatus and an image processing method capable of suppressing an increase in a load and improving coding efficiency.

### BACKGROUND ART

In recent years, devices which treat image information digitally, aim at transmitting and accumulating information with high efficiency, use redundancy unique to image information, and are based on methods such as MPEG (Moving Picture Experts Group) for compression through orthogonal transforms such as discrete cosine transform and motion compensation have become popular for both information transmission in broadcasting stations and information reception in ordinary homes.

Particularly, MPEG2 (ISO (International Organization for Standardization)/IEC (International Electrotechnical Commission) 13818-2), which is defined as a general purpose image coding method, is a standard including both an interlace scanning image and a progressive scanning image, and a standard resolution image and a high definition image, and is for wide use in various applications for professionals and consumers. By the use of the MPEG2 compression method, for example, a bit rate of 4 to 8 Mbps is allocated to an interlace scanning image of a standard resolution having 720×480 pixels, and a bit rate of 18 to 22 Mbps is allocated to an interface scanning image of high resolution having 1920×1088 pixels, thereby realizing high compression ratio and favorable image quality.

MPEG2 has mainly targeted high image quality coding suitable for broadcasting but does not support a bit rate lower than in MPEG1, that is, coding methods of higher compression ratio. With the popularization of portable terminals, demands for such coding methods are considered likely to increase in the future, and an MPEG4 coding method has been standardized so as to correspond thereto. In relation to the image coding method, a specification thereof is approved for international standards as ISO/IEC 14496-2 in December, 1998.

In addition, in recent years, originally for the purpose of image coding of video conference, standardization of H.26L (ITU-T (International Telecommunication Union Telecommunication Standardization Sector) Q6/16 VCEG (Video Coding Expert Group)) has progressed. H.26L requires a large amount of calculation in coding and decoding as compared with a coding method in the related art such as MPEG2 or MPEG4, but it is known to realize higher coding efficiency. In addition, at present, as a part of activities of MPEG4, standardization for incorporating functions which are not supported by H.26L and for realizing higher coding efficiency is being performed as Joint Model of Enhanced-Compression Video Coding on the basis of H.26L.

As standardization schedules, H.264 and MPEG-4 Part10 (Advanced Video Coding; hereinafter, referred to as AVC) has become international standards under those names in March, 2003.

Further, as an extension thereof, standardization of FRExt (Fidelity Range Extension) including a coding tool necessary for business such as RGB or 4:2:2 or 4:4:4, and 8×8 DCT or quantization matrix regulated in MPEG2 has been completed in February, 2005, and, thereby, the coding method can also favorably express film noise included in a movie using AVC and is used for various applications such as a Blu-ray disc.

However, nowadays, there is an increasing demand for further higher compression ratio coding since an image of approximately 4096×2048 pixels which is the size of four times that of a high vision image is desired to be compressed, or a high vision image is desired to be delivered in circumstances of restricted transmission capacity such as the Internet. For this reason, investigations regarding improvement in coding efficiency are ongoing in VCEG affiliated to the above-described ITU-T.

However, in MPEG1, MPEG2, ITU-T H.264, and MPEG4-AVC which are image coding methods hitherto, the pixel size of the macro block which is the image division unit (coding process unit) at the time of image coding is entirely 16×16 pixels. On the other hand, NPL1 has proposed that the number of pixels of the macro block in the horizontal and vertical directions be extended as an elemental technology of an image coding specification of the next generation. According to the proposal, it has been proposed that a macro block formed of 32×32 pixels or 64×64 pixels is used in addition to the pixel size of the macro block of 16×16 pixels regulated in MPEG1, MPEG2, ITU-T H.264, MPEG4-AVC, and the like. This is expected to increase the pixel size of an image to be coded in the horizontal and vertical directions in the future, but, in this case, is aimed at improving coding efficiency by performing motion compensation and orthogonal transform using a larger region as the unit in regions where motions are similar to each other.

As evaluation indices in a motion search, a first method is considered as, for example, a block matching method of searching for a minimum point of a sum of absolute differences (hereinafter, referred to as SAD) between a target image and a reference image. For example, as shown in A of FIG. 1, an extended macro block (EBS (Extended Block Size)) of the size larger than 16×16 pixels is divided into regions of 16×16 pixels, and a search is performed in each region in the same manner as the case of the macro block of the 16×16 pixel size. For example, when 64×64 pixels are searched using this method, a device which has a performance for searching the existing 16×16 pixels may be driven 16 times in a time division manner.

In addition, a second method is considered as a method in which, for example, as shown in B of FIG. 1, SAD is calculated by using the entire macro block (for example, 64×64 pixels) as a single region.

### CITATION LIST

### Non Patent Literature

NPL 1: Peisong Chenn, Yan Ye, Marta Karczewicz, “Video Coding Using Extended Block Sizes”, COM16-C123-E, Qualcomm Inc

### SUMMARY OF INVENTION

### Technical Problem

However, in a case of the first method, since the macro block of 64×64 pixels is divided into 4×4 pixels and a search is performed in each block, results of all the search points are required to be added and held every 16×16 pixels until a search in the lower right block from a search in the upper left block finishes. Therefore, there is concern that massive amounts of data are required to be held and thus resources necessary for a coding process are increased. In addition, there is concern that delay occurs with the units of 16 macro blocks.

In addition, in order to realize the second method, a processing performance for calculating SAD of an amount corresponding to 64×64 pixels is necessary.

The present invention has been made in consideration of these circumstances, and an object thereof is to be capable of suppressing an increase in a load in a coding process and improving coding efficiency.

### Solution to Problem

One aspect of the present invention is an image processing apparatus including resolution determining means for determining a size of a resolution of an image of a partial region in an image where each partial region is coded; and motion search means for performing a motion search using the image of the partial region of a resolution corresponding to the size of the resolution determined by the resolution determining means, in the partial region.

The image processing apparatus may further include resolution converting means for converting the resolution of the image of the partial region; and selecting means for selecting the image of the partial region of which the resolution is converted by the resolution converting means if it is determined that the resolution of the image of the partial region is larger than a predetermined threshold value by the resolution determining means, and selecting the image of the partial region of which the resolution is not converted by the resolution converting means if it is determined that the resolution of the image of the partial region is equal to or less than the threshold value, and, here, the motion search means may perform a motion search using the image of the partial region selected by the selecting means.

The threshold value may be a maximum value of resolutions of a partial region regulated by an existing coding specification.

The threshold value may be 16×16 pixels.

The resolution converting means may convert the resolution of the image of the partial region into a plurality of resolutions, the resolution determining means may determine a size of the resolution of the image of the partial region for a plurality of threshold values, and the selecting means may select either of the image of the partial region of the plurality of resolutions obtained by the resolution converting means converting the resolution and the image of the partial region before the resolution is converted, depending on magnitude correlation between the size of the resolution of the image of the partial region by the resolution determining means and the plurality of threshold values.

The image processing apparatus may further include precision converting means for converting precision of a motion vector detected by the motion search of the motion search means into precision in the resolution of the image of the partial region before being converted by the resolution converting means.

The image processing apparatus may further include motion compensation means for performing motion compensation using the motion vector of which precision is converted by the precision converting means and the image of the partial region before being converted by the resolution converting means, and generating a predicted image.

The image processing apparatus may further include coding means for coding the image of the partial region using the predicted image generated by the motion compensation means.

The image processing apparatus may further include motion compensation means for performing motion compensation using a motion vector detected by the motion search of the motion search means and the image of the partial region selected by the selecting means, and generating a predicted image.

The image processing apparatus may further include coding means for coding the image of the partial region using the predicted image generated by the motion compensation means.

The image processing apparatus according may further include first resolution converting means for converting a resolution of the image of the partial region to be coded; first selecting means for selecting the image of the partial region of which the resolution is converted by the first resolution converting means if it is determined that the resolution of the image of the partial region to be coded is larger than a predetermined threshold value, and selecting the image of the partial region to be coded of which the resolution is not converted by the first resolution converting means if it is determined that the resolution of the image of the partial region to be coded is equal to or less than the threshold value; second resolution converting means for converting a resolution of a decoded image of the partial region obtained by decoding the coded image of the partial region; and second selecting means for selecting the decoded image of the partial region of which the resolution is converted by the second resolution converting means if it is determined that the resolution of the image of the partial region to be coded is larger than a predetermined threshold value by the resolution determining means, and selecting the decoded image of the partial region of which the resolution is not converted by the second resolution converting means if it is determined that the resolution of the image of the partial region to be coded is equal to or less than the threshold value, and, here, the motion search means may perform a motion search using the image of the partial region selected by the first selecting means as an input image and using the decoded image of the partial region selected by the second selecting means as a reference image.

The motion search means may perform a motion search at a plurality of predetermined precisions using the image of the partial region.

One aspect of the present invention is an image processing method of an image processing apparatus including causing resolution determining means to determine a size of a resolution of an image of a partial region in an image where each partial region is coded; and causing motion search means to perform a motion search using the image of the partial region of a resolution corresponding to the determined size of the resolution, in the partial region.

Another aspect of the present invention is an image processing apparatus including decoding means for decoding coded data which is obtained by converting a resolution of an image from a first resolution to a second resolution for each partial region and by coding the image, for each partial region; and motion compensation means for performing motion compensation using an image of the partial region of the second resolution obtained by being decoded by the decoding means and generating a predicted image of the second resolution which is used for decoding the coded data by the decoding means.

The image processing apparatus may further include first resolution converting means for converting a resolution of the image of the partial region obtained by being decoded by the decoding means into the first resolution; and second resolution converting means for converting the image of the partial region of the first resolution obtained by being converted by the first resolution converting means into the second resolution, and, here, the motion compensation means may perform motion compensation using an image of the partial region of the second resolution obtained by being converted by the second resolution converting means.

Another aspect of the present invention is an image processing method of an image processing apparatus including causing decoding means to decode coded data which is obtained by converting a resolution of an image from a first resolution to a second resolution for each partial region and by coding the image, for each partial region; and causing motion compensation means to perform motion compensation using an image of the partial region of the second resolution obtained by being decoded and to generate a predicted image of the second resolution which is used for decoding the coded data.

In one aspect of the present invention, a size of a resolution of an image of a partial region is determined in an image where each partial region is coded, and a motion search is performed using the image of the partial region of a resolution corresponding to the determined size of the resolution in the partial region.

In another aspect of the present invention, coded data which is obtained by converting a resolution of an image from a first resolution to a second resolution for each partial region and by coding the image, is decoded for each partial region, motion compensation is performed using an image of the partial region of the second resolution obtained by being decoded and a predicted image of the second resolution which is used for decoding the coded data is generated.

### ADVANTAGEOUS EFFECTS OF INVENTION

According to the present invention, it is possible to code image data or decode coded image data. Particularly, it is possible to improve coding efficiency while suppressing an increase in a load.

### BRIEF DESCRIPTION OF DRAWINGS

FIG. 1 is a diagram illustrating an example of the motion search method in the related art.

FIG. 2 is a block diagram illustrating a main configuration example of the image coding device to which the present invention is applied.

FIG. 3 is a diagram illustrating an example of the macro block.

FIG. 4 is a diagram illustrating an example of the state where the macro block is reduced.

FIG. 5 is a block diagram illustrating a configuration example of the motion search and compensation unit.

FIG. 6 is a flowchart illustrating an example of the flow of the coding process.

FIG. 7 is a flowchart illustrating an example of the flow of the prediction process.

FIG. 8 is a flowchart illustrating an example of the flow of the inter-motion prediction process.

FIG. 9 is a timing chart illustrating an example of the state of the flow of the motion search process and the motion compensation process.

FIG. 10 is a flowchart illustrating another example of the flow of the inter-motion prediction process.

FIG. 11 is a block diagram illustrating another configuration example of the image coding device to which the present invention is applied.

FIG. 12 is a diagram illustrating an example of the macro block.

FIG. 13 is a diagram illustrating another example of the state where the macro block is reduced.

FIG. 14 is a block diagram illustrating another configuration example of the motion search and compensation unit.

FIG. 15 is a flowchart illustrating still another example of the flow of the inter-motion prediction process.

FIG. 16 is a timing chart illustrating an example of the state of the flow of the motion search process and the motion compensation process.

FIG. 17 is a block diagram illustrating still another configuration example of the image coding device to which the present invention is applied.

FIG. 18 is a block diagram illustrating still another configuration example of the motion search and compensation unit.

FIG. 19 is a flowchart illustrating still another example of the flow of the inter-motion prediction process.

FIG. 20 is a block diagram illustrating a main configuration example of the image decoding device to which the present invention is applied.

FIG. 21 is a flowchart illustrating an example of the flow of the decoding process.

FIG. 22 is a flowchart illustrating an example of the flow of the prediction process.

FIG. 23 is a flowchart illustrating an example of the flow of the inter-motion prediction process.

FIG. 24 is a block diagram illustrating a main configuration example of the personal computer to which the present invention is applied.

FIG. 25 is a block diagram illustrating a main configuration example of the television receiver to which the present invention is applied.

FIG. 26 is a block diagram illustrating a main configuration example of the mobile phone to which the present invention is applied.

FIG. 27 is a block diagram illustrating a main configuration example of the hard disk recorder to which the present invention is applied.

FIG. 28 is a block diagram illustrating a main configuration example of the camera to which the present invention is applied.

### DESCRIPTION OF EMBODIMENTS

Hereinafter, embodiments will be described. The description will be made in the following order.

1. First Embodiment (image coding device)

2. Second Embodiment (image coding device)

3. Third Embodiment (image coding device)

4. Fourth Embodiment (image decoding device)

5. Fifth Embodiment (personal computer)

6. Sixth Embodiment (television receiver)

7. Seventh Embodiment (mobile phone)

8. Eighth Embodiment (hard disk recorder)

9. Ninth Embodiment (camera)

### 1. First Embodiment

[Image Coding Device]

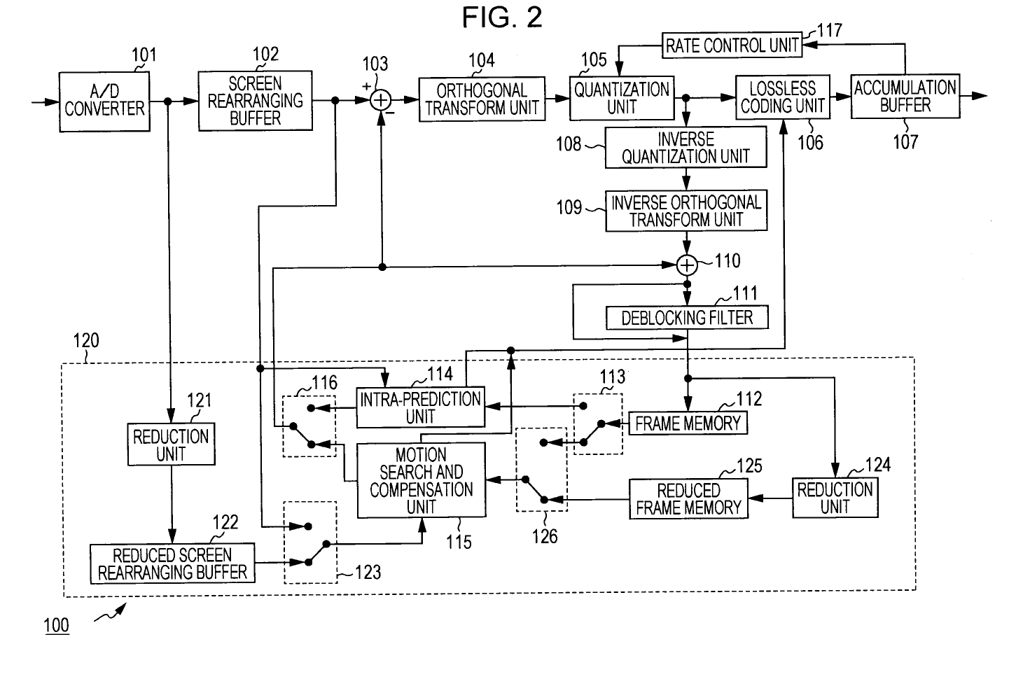

FIG. 2 shows a configuration of an embodiment of the image coding device as an image processing device to which the present invention is applied.

The image coding device 100 shown in FIG. 2 is a coding device which compresses and codes an image using, for example, an H.264 and MPEG (Moving Picture Experts Group) 4 Part10 (AVC (Advance Video Coding)) (hereinafter, referred to as H.264/AVC) method. However, the image coding device 100 performs a motion search using a reduced image of a macro block when performing inter-coding of an extended macro block.

In the example shown in FIG. 2, the image coding device 100 includes an A/D (Analog/Digital) conversion unit 101, a screen rearranging buffer 102, a calculation unit 103, an orthogonal transform unit 104, a quantization unit 105, a lossless coding unit 106, and an accumulation buffer 107. In addition, the image coding device 100 includes an inverse quantization unit 108, an inverse orthogonal transform unit 109, a calculation unit 110, a deblocking filter 111, a frame memory 112, a selection unit 113, an intra-prediction unit 114, a motion search and compensation unit 115, a selection unit 116, and a rate control unit 117. These processing units are the same as processing units of an image coding device based on the H.264/AVC specification.

The image coding device 100 further includes a reduction unit 121, a reduced screen rearranging buffer 122, a selection unit 123, a reduction unit 124, a reduced frame memory 125, and a selection unit 127.

The frame memory 112 to the selection unit 116, and the reduction unit 121 to the selection unit 127 form a predicted image generation section 120 which generates a predicted image.

The A/D conversion unit 101 A/D converts input image data so as to be output to and stored in the screen rearranging buffer 102. In addition, the A/D conversion unit 101 also supplies the A/D converted image data to the reduction unit 121.

The screen rearranging buffer 102 rearranges images of frames in a stored display order into frames in an order for decoding according to a GOP (Group of Picture) structure. The screen rearranging buffer 102 supplies the images where the order of the frames is changed to the calculation unit 103 and the intra-prediction unit 114. In addition, the screen rearranging buffer 102 also supplies the images where the order of the frames is changed to the motion search and compensation unit 115 via the selection unit 123.

The calculation unit 103 subtracts a predicted image supplied from the intra-prediction unit 114 or the motion search and compensation unit 115 via the selection unit 116, from the image read from the screen rearranging buffer 102, and outputs difference information thereof to the orthogonal transform unit 104.

For example, in a case of an image undergoing intra-coding, the calculation unit 103 subtracts a predicted image supplied from the intra-prediction unit 114, from the image read from the screen rearranging buffer 102. In addition, for example, in a case of an image undergoing inter-coding, the calculation unit 103 subtracts a predicted image supplied from the motion search and compensation unit 115, from the image read from the screen rearranging buffer 102.

The orthogonal transform unit 104 performs orthogonal transform such as discrete cosine transform or Karhunen-Loeve transform for the difference information supplied from the calculation unit 103, and supplies transform coefficients thereof to the quantization unit 105. The quantization unit 105 quantizes the transform coefficients output by the orthogonal transform unit 104. The quantization unit 105 supplies the quantized transform coefficients to the lossless coding unit 106.

The lossless coding unit 106 performs lossless coding such as variable length coding or arithmetic coding for the quantized transform coefficients.

The lossless coding unit 106 acquires information or the like indicating intra-prediction from the intra-prediction unit 114, and acquires information indicating inter-prediction mode, motion vector information, or the like from the motion search and compensation unit 115. In addition, information indicating the intra-prediction (intra-screen prediction) is hereinafter also referred to as intra-prediction mode information. In addition, information indicating an information mode indicating the inter-prediction (inter-screen prediction) is hereinafter also referred to as inter-prediction mode information.

The lossless coding unit 106 codes the quantized transform coefficients, and sets (multiplexes) a variety of information such as filter coefficients, the intra-prediction mode information, the inter-prediction mode information, and quantization parameters as a portion of header information of coded data. The lossless coding unit 106 supplies the coded data obtained through the coding to the accumulation buffer 107 so as to be accumulated.

For example, in the lossless coding unit 106, a lossless coding process such as variable length coding or arithmetic coding is performed. The variable length coding may include CAVLC (Context-Adaptive Variable Length Coding) defined in the H.264/AVC method. The arithmetic coding may include CABAC (Context-Adaptive Binary Arithmetic Coding).

The accumulation buffer 107 temporarily holds the coded data supplied from the lossless coding unit 106, and outputs the data to, for example, a recording device or a transmission path (not shown) in the subsequent stage at a predetermined timing, as a coded image which is coded using the H.264/AVC method.

In addition, the quantized transform coefficients in the quantization unit 105 are also supplied to the inverse quantization unit 108. The inverse quantization unit 108 inversely quantizes the quantized transform coefficients using a method corresponding to the quantization performed by the quantization unit 105, and supplies the obtained transform coefficients to the inverse orthogonal transform unit 109.

The inverse orthogonal transform unit 109 performs inverse orthogonal transform for the supplied transform coefficients using a method corresponding to the orthogonal transform process performed by the orthogonal transform unit 104. The output (restored difference information) having undergone the inverse orthogonal transform is supplied to the calculation unit 110.

The calculation unit 110 adds a predicted image supplied from the intra-prediction unit 114 or the motion search and compensation unit 115 via the selection unit 116, to the inverse orthogonal transform result supplied from the inverse orthogonal transform unit 109, that is, the restored difference information, thereby obtaining a partially decoded image (decoded image).

For example, in a case where the difference information corresponds to an image undergoing intra-coding, the calculation unit 110 adds a predicted image supplied from the intra-prediction unit 114 to the difference information. In addition, for example, in a case where the difference information corresponds to an image undergoing inter-coding, the calculation unit 110 adds a predicted image supplied from the motion search and compensation unit 115 to the difference information.

The addition result is supplied to the deblocking filter 111 or the frame memory 112.

The deblocking filter 111 removes block distortion of the decoded image by performing an appropriate deblocking filter process, and improves image quality by an appropriate loop filter process using, for example, a Wiener filter. The deblocking filter 111 generates classes of pixels, and performs an appropriate filter process for each class. The deblocking filter 111 supplies the filter process result to the frame memory 112 and the reduction unit 124.

The frame memory 112 outputs an accumulated reference image to the intra-prediction unit 114 or the motion search and compensation unit 115 via the selection unit 113 or the selection unit 126 at a predetermined timing.

For example, in a case of an image undergoing intra-coding, the frame memory 112 supplies the reference image to the intra-prediction unit 114 via the selection unit 113. In addition, in a case of an image undergoing inter-coding and the macro block size thereof being smaller than a predetermined size, the frame memory 112 supplies the reference image to the motion search and compensation unit 115 via the selection unit 113 and the selection unit 126.

In the image coding device 100, for example, an I picture, a B picture, and a P picture from the screen rearranging buffer 102 are supplied to the intra-prediction unit 114 as images undergoing intra-prediction (also referred to as an intra-process). In addition, a B picture and a P picture read from the screen rearranging buffer 102 are supplied to the motion search and compensation unit 115 via the selection unit 123 as images undergoing inter-prediction (also referred to as inter-process).

In a case where the reference image supplied from the frame memory 112 is an image undergoing intra-coding, the selection unit 113 supplies the reference image to the intra-prediction unit 114. In addition, in a case where the reference image supplied from the frame memory 112 is an image undergoing inter-coding, the selection unit 113 supplies the reference image to the motion search and compensation unit 115.

The intra-prediction unit 114 performs intra-prediction (intra-screen prediction) for generating a predicted image using pixel values in the screen. The intra-prediction unit 114 performs the intra-prediction in a plurality of modes (intra-prediction modes).

The intra-prediction unit 114 generates predicted images in all the intra-prediction modes, and selects an optimal mode by evaluating each predicted image. When the optimal intra-prediction mode is selected, the intra-prediction unit 114 supplies the predicted image generated in the optimal mode to the calculation unit 103 via the selection unit 116.

In addition, as described above, the intra-prediction unit 114 appropriately supplies information such as the intra-prediction mode information indicating an employed intra-prediction mode to the lossless coding unit 106.

The motion search and compensation unit 115 searches the image undergoing inter-coding for a motion vector, using the input image supplied from the selection unit 123 and the reference image supplied from the selection unit 126, and performs motion compensation according to the detected motion vector so as to generate a predicted image (inter-prediction image information).

The motion search and compensation unit 115 performs a motion search using a reduced image obtained by reducing the input image, for example, in a macro block with the size larger than a predetermined size such as an extended macro block larger than a macro block of 16×16 pixels regulated by AVC. Details thereof will be described.

The motion search and compensation unit 115 performs inter-prediction processes in all the inter-prediction modes which become candidates, thereby generating predicted images. The motion search and compensation unit 115 supplies the generated predicted images to the calculation unit 103 or the calculation unit 110 via the selection unit 116.

Further, the motion search and compensation unit 115 supplies intra-prediction mode information indicating an employed inter-prediction mode or motion vector information indicating a calculated motion vector to the lossless coding unit 106.

In a case of an image undergoing intra-coding, the selection unit 116 supplies the output from the intra-prediction unit 114 to the calculation unit 103 or the calculation unit 110, and, in a case of an image undergoing inter-coding, supplies the output from the motion search and compensation unit 115 to the calculation unit 103 or the calculation unit 110.

The rate control unit 117 controls a rate of a quantization operation of the quantization unit 105 on the basis of compressed images accumulated in the accumulation buffer 107 such that overflow or underflow does not occur.

The reduction unit 121 converts the size (resolution) of the input image output from the A/D conversion unit 101. For example, the reduction unit 121 reduces the size at a predetermined reduction ratio N. An image may be reduced using any method. For example, representative pixel values may be extracted at a ratio according to a reduction ratio, or an average value may be calculated for each number of pixels according to a reduction ratio.

For example, the reduction unit 121 reduces the input image for the purpose of reducing an image of a macro block with the size larger than a preset size (threshold value) so as to have a size equal to or smaller than the preset size (threshold value). For example, the reduction unit 121 reduces an image of an extended macro block of 64×64 pixels, 32×32 pixels, or the like, so as to have 16×16 pixels or less which is the macro block size used in a specification such as AVC.

For example, if an image of 64×64 pixels is reduced to an image of 16×16 pixels, a reduction ratio is N=4. That is to say, the image size is reduced to 1/N². As such, a value of the reduction ratio N is set in consideration of a size of an image to be reduced and a threshold value of the image size.

Generally, a size of a macro block of an input image to be reduced is selected from a plurality of preset sizes and is set, and a range of allowable values is limited. In addition, any threshold value can be set. Therefore, the reduction ratio N may be preferably set such that the maximum size of a macro block of an input image to be reduced becomes equal to or less than the threshold value.

Basically, the threshold value or the reduction ratio N is a fixed value which is set in advance before starting an image coding process. However, for example, the threshold value or the reduction ratio may be set to be varied during the image coding process according to a content of an image.

Hereinafter, a description will be made assuming that 16×16 pixels which are the size of the macro block used in AVC or the like are set as a threshold value, and an extended macro block with the size larger than 16×16 pixels is a target to be reduced.

When an input image is reduced, the reduction unit 121 supplies the reduced image to the reduced screen rearranging buffer 122 so as to be stored. The reduced screen rearranging buffer 122 holds the reduced image supplied from the reduction unit 121, and when an output from the reduced screen rearranging buffer 122 is selected by the selection unit 123, the reduced screen rearranging buffer 122 supplies the reduced image held to the motion search and compensation unit 115 via the selection unit 123.

The selection unit 123 selects either of the output from the screen rearranging buffer 102 and the output from the reduced screen rearranging buffer 122 as an input image supplied to the motion search and compensation unit 115.

The image output from the screen rearranging buffer 102 is an input image with the original size which is not reduced. In contrast, the image output from the reduced screen rearranging buffer 122 is an input image which is reduced at the reduction ratio N in the reduction unit 121.

In other words, when the motion search and compensation unit 115 performs a motion search using a reduced image, the selection unit 123 selects the output from the reduced screen rearranging buffer 122 and supplies the output image to the motion search and compensation unit 115 as an input image. In other words, more specifically, when the motion search and compensation unit 115 performs a motion search in an extended macro block, the selection unit 123 selects a reduced image output from the reduced screen rearranging buffer 122 and supplies it to the motion search and compensation unit 115 as an input image.

In addition, when the motion search and compensation unit 115 performs a motion search using an image which is not reduced, the selection unit 123 selects the output from the screen rearranging buffer 102 and supplies the output image to the motion search and compensation unit 115 as an input image. In other words, more specifically, when the motion search and compensation unit 115 performs a motion search in a macro block of 16×16 pixels or less, the selection unit 123 selects the image output from the screen rearranging buffer 102 and supplies it to the motion search and compensation unit 115 as an input image.

The reduction unit 124, in the same manner as the reduction unit 121, converts a size (resolution) of a partially decoded image which is output from the deblocking filter 111. For example, the reduction unit 124 reduces the image at a predetermined reduction ratio N. The reduction ratio N is common to the reduction unit 121. The reduction unit 124 supplies the reduced image generated to the reduced frame memory 125.

The reduced frame memory 125 holds the reduced image supplied from the reduction unit 124 and supplies the reduced image held to the motion search and compensation unit 115 via the selection unit 126 as a reference image when an output from the reduced frame memory 125 is selected by the selection unit 126.

The selection unit 126 selects either of the output from the selection unit 113 (the frame memory 112) and the output from the reduced frame memory 125 as a reference image supplied to the motion search and compensation unit 115, and supplies a selected output to the motion search and compensation unit 115 as a reference image.

The image output from the frame memory 112 via the selection unit 113 is a reference image with the original size which is not reduced. In contrast, the image output from the reduced frame memory 125 is a reference image which is reduced at the reduction ratio N in the reduction unit 124.

That is to say, when the motion search and compensation unit 115 performs a motion search using the reduced image as a reference image, the selection unit 126 selects the output from the reduced frame memory 125 and supplies the output image to the motion search and compensation unit 115 as a reference image. In other words, more specifically, when the motion search and compensation unit 115 performs a motion search in an extended macro block, the selection unit 126 selects the reduced image output from the reduced frame memory 125 and supplies it to the motion search and compensation unit 115 as a reference image.

In addition, when the motion search and compensation unit 115 performs a motion search using an image which is not reduced, the selection unit 123 selects the output from the selection unit 113 (the frame memory 112) and supplies the output image to the motion search and compensation unit 115 as a reference image. In other words, more specifically, when the motion search and compensation unit 115 performs a motion search in a macro block of 16×16 pixels or less, the selection unit 123 selects the image output from the selection unit 113 (the frame memory 112) and supplies it to the motion search and compensation unit 115 as a reference image.

As such, when the motion search and compensation unit 115 performs a motion search using an image with the size larger than a predetermined size such as the extended macro block, the motion search can be more easily performed by using the reduced image. In addition, when the motion search is performed using an image with the size smaller than a predetermined size, the motion search and compensation unit 115 can suppress undesired reduction in precision of a motion vector by using an image with the original size which is not reduced.

In addition, the motion search and compensation unit 115 performs a motion compensation process using a reference image with the original size which is not reduced in any case.

[Macro Block]

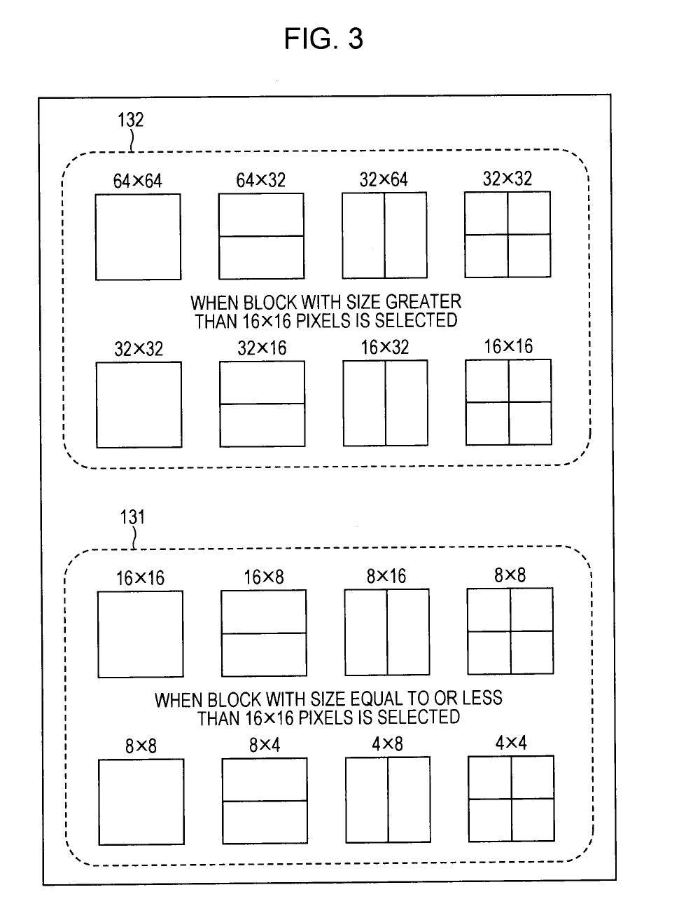

FIG. 3 shows an example of the macro block size. As shown in FIG. 3, any size of the macro block may be used, and an extended macro block larger than the macro block of 16×16 pixels or less used in AVC such as 64×64 pixels or 32×32 pixels may be set.

For example, if the macro block of 16×16 pixels or less used in AVC, surrounded by the dotted line 131, is a coding process target, the motion search and compensation unit 115 performs a motion search using an image with the original size which is not reduced as described above. In addition, for example, if the extended macro block with the size larger than 16×16 pixels, surrounded by the dotted line 132, is a coding process target, the motion search and compensation unit 115 performs a motion search using a reduced image as described above.

[Reduction]

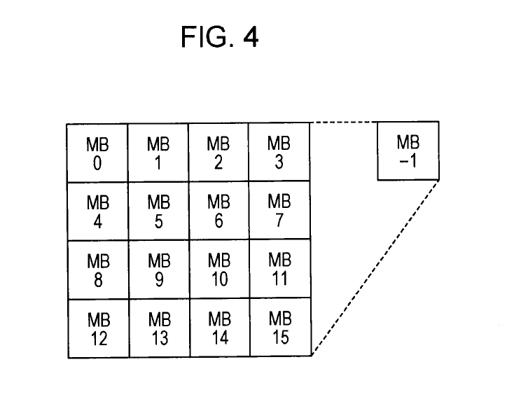

In a case of N=4, the reduction unit 121 and the reduction unit 124, for example, as shown in FIG. 4, generate a single macro block (MB-1) of 16×16 pixels from an extended macro block of 64×64 pixels corresponding to 4×4 macro blocks (MB0 to MB15) of 16×16 pixels.

The motion search and compensation unit 115 performs a motion search in the macro block (MB-1). Therefore, the motion search and compensation unit 115 can perform a motion search in the extended macro block of 64×64 pixels in the same load as in a case where a motion search is performed in a single macro block of 16×16 pixels used in AVC or the like.

[Configuration of Motion Search and Compensation Unit]

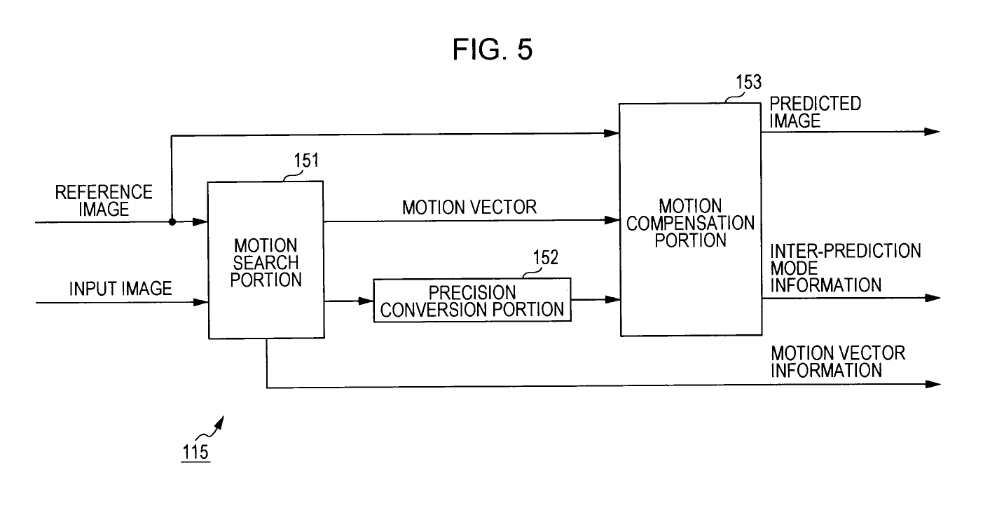

FIG. 5 is a block diagram illustrating a configuration example of the motion search and compensation unit 115 inside the image coding device 100 shown in FIG. 2.

As shown in FIG. 5, the motion search and compensation unit 115 includes a motion search portion 151, a precision conversion portion 152, and a motion compensation portion 153. The motion search portion 151 performs a motion search using the input image supplied from the selection unit 123 and the reference image supplied from the selection unit 126. In a case where the motion search portion 151 performs the motion search using the input image or the reference image with the original size which is not reduced, a variety of parameters such as a detected motion vector are supplied to the motion compensation portion 153.

In contrast, when the motion search is performed using the reduced image, the precision of a detected motion vector is decreased by N times. Therefore, the motion search portion 151 supplies a variety of parameters such as the detected motion vector to the precision conversion portion 152.

The precision conversion portion 152 increases the precision of the supplied motion vector by N times so as to be supplied to the motion compensation portion 153.

The motion search portion 151 performs a motion search at integer precision, ½ precision finer than that, and ¼ precision further finer than that. For example, in a case of a macro block of 16×16 pixels or less, the motion search portion 151 performs a motion search using an image with the original size which is not reduced, and thus can detect a motion vector up to ¼ precision. In contrast, in a case of an extended macro block, the motion search portion 151 performs a motion search using a reduced image, and thus can detect a motion vector only up to N/4 precision.

The precision conversion portion 152 converts the precision of the detected motion vector using the reduced image in this way so as to be adjusted to the normal precision of the motion vector detected using the image with the original size which is not reduced.

The motion compensation portion 153 generates a predicted image by performing motion compensation using the parameters supplied from the motion search portion 151 or the precision conversion portion 152, and the image with the original size which is not reduced, supplied from the selection unit 126.

The motion compensation portion 153 supplies the generated predicted image to the selection unit 116. In addition, the motion compensation portion 153 supplies the inter-prediction mode information to the lossless coding unit 106. Further, the motion search portion 151 supplies motion vector information indicating the detected motion vector to the lossless coding unit 106.

[Coding Process]

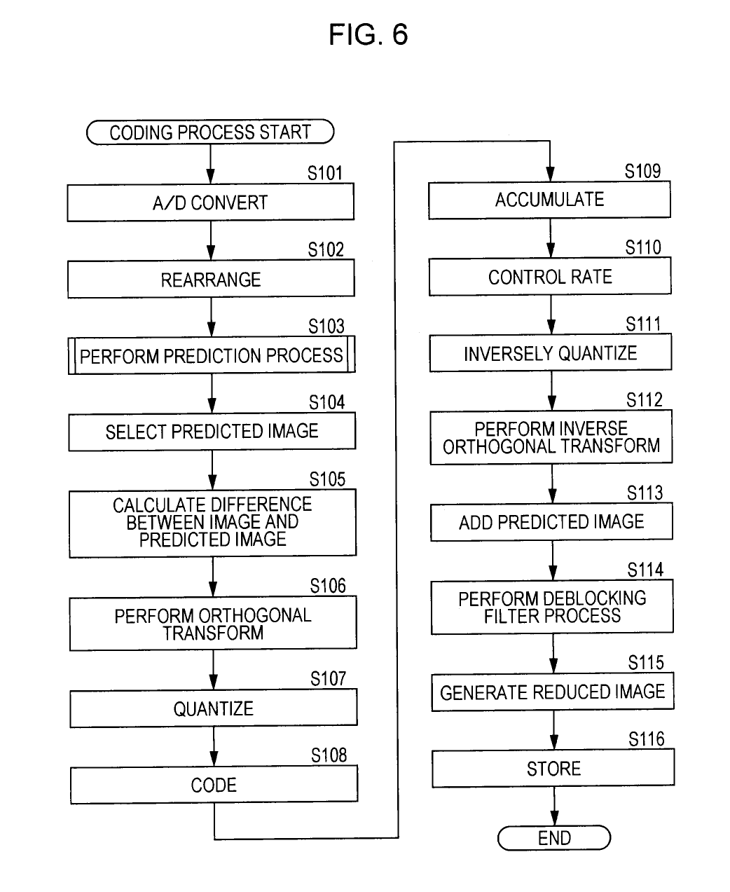

Next, a flow of each process executed by the image coding device 100 as described above will be described. First, an example of the flow of the coding process will be described with reference to the flowchart of FIG. 6.

In step S101, the A/D conversion unit 101 A/D converts an input image. In step S102, the screen rearranging buffer 102 stores the A/D converted images, and changes an order that the respective pictures are displayed to an order that they are coded.

In step S103, the respective units of the predicted image generation section 120 perform a prediction process of an image.

For example, the intra-prediction unit 114 performs an intra-prediction process in the intra-prediction mode, and the motion search and compensation unit 115 performs a motion prediction compensation process in the inter-prediction mode.

In step S104, the selection unit 116 sets an optimal prediction mode on the basis of the respective cost function values output from the intra-prediction unit 114 and the motion search and compensation unit 115. In other words, the selection unit 116 selects either of the predicted image generated by the intra-prediction unit 114 and the predicted image generated by the motion search and compensation unit 115.

In addition, selection information indicating which predicted image is selected is supplied to either of the intra-prediction unit 114 and the motion search and compensation unit 115 which has output the selected predicted image. In a case where a predicted image in the optimal intra-prediction mode is selected, the intra-prediction unit 114 supplies information (that is, intra-prediction mode information) indicating the optimal intra-prediction mode to the lossless coding unit 106.

In a case where a predicted image in the optimal inter-prediction mode is selected, the motion search and compensation unit 115 outputs information indicating the optimal inter-prediction mode, and, as necessary, information corresponding to the optimal inter-prediction mode, to the lossless coding unit 106. As the information corresponding to the optimal inter-prediction mode, motion vector information, flag information, reference frame information, or the like may be given.

In step S105, the calculation unit 103 calculates a difference between the image rearranged through the process in step S102 and the predicted image obtained through the prediction process in step S103. The predicted image is supplied to the calculation unit 103 via the selection unit 116, from the motion search and compensation unit 115 in a case of inter-prediction and from the intra-prediction unit 114 in a case of intra-prediction.

The difference data is reduced in a data amount as compared with original image data. Therefore, the data amount can be compressed as compared with a case where an image is coded as it is.

In step S106, the orthogonal transform unit 104 performs orthogonal transform for the difference information generated through the process in step S105. Specifically, transform coefficients are output through the orthogonal transform such as discrete cosine transform or Karhunen-Loeve transform. In step S107, the quantization unit 105 quantizes the transform coefficients generated through the process in step S106.

In step S108, the lossless coding unit 106 codes the transform coefficients quantized through the process in step S107. In other words, lossless coding such as variable length coding or arithmetic coding is performed for the difference image (in a case of inter, secondary difference image).

In addition, the lossless coding unit 106 codes information regarding a predication mode of the predicted image selected through the process in step S104, and adds the information to header information of coded data obtained by coding the difference image.

That is to say, the lossless coding unit 106 also codes the intra-prediction mode information supplied from the intra-prediction unit 114, information corresponding to the optimal inter-prediction mode supplied from the motion search and compensation unit 115, or the like, so as to be added to the header information.

In step S109, the accumulation buffer 107 accumulates the coded data output from the lossless coding unit 106. The coded data accumulated in the accumulation buffer 107 is appropriately read and is transmitted to a decoding side via a transmission path.

In step S110, the rate control unit 117 controls a rate of a quantization operation of the quantization unit 105 such that overflow or underflow does not occur on the basis of the compressed images accumulated in the accumulation buffer 107 through the process in step S109.

In addition, the difference information quantized through the process in step S107 is partially decoded as follows. In other words, in step S111, the inverse quantization unit 108 inversely quantizes the quantization coefficients generated through the process in step S107 using characteristics corresponding to the characteristics of the quantization unit 105. In step S112, the inverse orthogonal transform unit 109 performs inverse orthogonal transform for the transform coefficients obtained through the process in step S111 using characteristics corresponding to the characteristics of the orthogonal transform unit 104.

In step S113, the calculation unit 110 adds the predicted image selected through the process in step S104 to the partially decoded difference information (the image corresponding to the input to the calculation unit 103), thereby generating a partially decoded image. In step S114, the deblocking filter 111 filters the image generated through the process in step S113. Thereby, block distortion is removed.

In step S115, the reduction unit 124 reduces the image from which the block distortion is removed through the process in step S114 at a reduction ratio N.

In step S116, the frame memory 112 stores the image from which the block distortion is removed through the process in step S114. In addition, an image which does not undergo a filter process in the deblocking filter 111 is also supplied from the calculation unit 110 and is stored in the frame memory 112. Further, the reduced frame memory 125 stores the reduced image generated through the process in step S115.

When the process in step S116 is completed, the coding process finishes. The coding process is, for example, repeatedly performed for each macro block.

[Prediction Process]

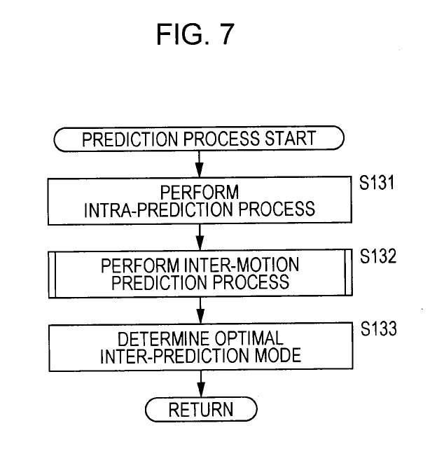

Next, with reference to the flowchart of FIG. 7, a description will be made of an example of the flow of the prediction process executed in step S103 of FIG. 6.

In step S131, the predicted image generation section 120 (the intra-prediction unit 114) performs intra-prediction for pixels of a block to be processed in all the intra-prediction modes which are candidates.

In a case where an image which is supplied from the screen rearranging buffer 102 and a processing target is an image undergoing an inter-process, an image which is referred to is read from the frame memory 112 and is supplied to the motion search and compensation unit 115 via the selection unit 113. The motion search and compensation unit 115 performs the inter-motion prediction process on the basis of the image in step S132. The predicted image generation section 120 performs a motion prediction process in all the inter-prediction modes which are candidates.

In step S133, the motion search and compensation unit 115 sets a prediction mode which gives a minimum value as an optimal inter-prediction mode among the cost function values in the inter-prediction modes, calculated in step S132. In addition, the motion search and compensation unit 115 supplies a difference between the image undergoing the inter-process and secondary difference information generated in the optimal inter-prediction mode, and a cost function value in the optimal inter-prediction mode, to the selection unit 116.

[Inter-Motion Prediction Process]

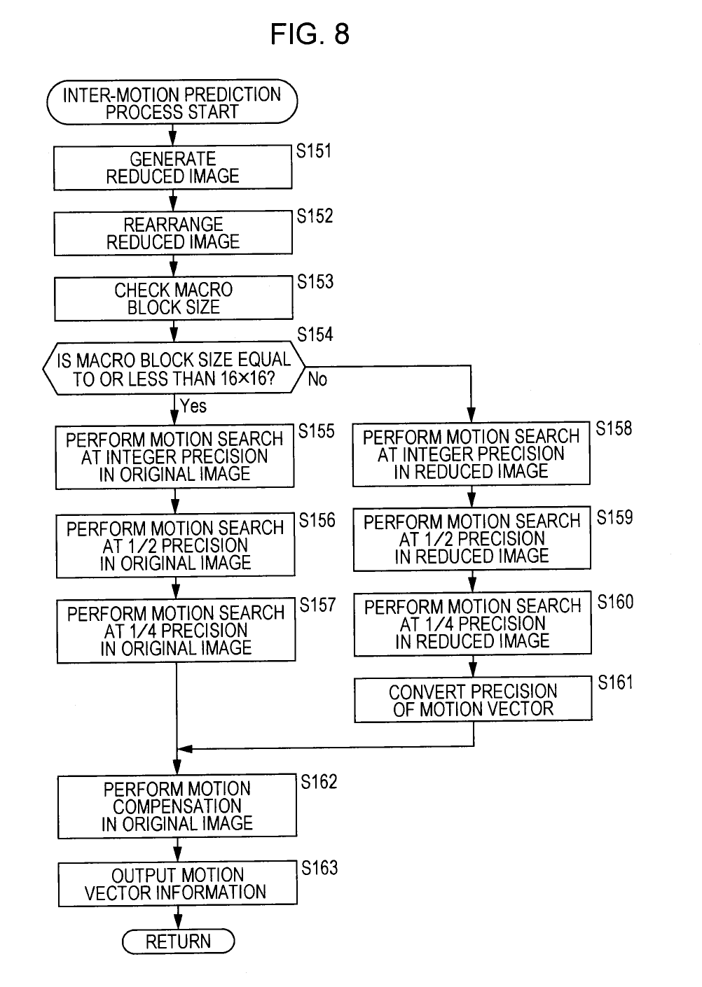

FIG. 8 is a flowchart illustrating an example of the flow of the inter-motion prediction process executed in step S132 of FIG. 7.

If the inter-motion prediction process starts, the reduction unit 121 reduces an input image at a reduction ratio N and generates a reduced image of the input image in step S151. In step S152, the reduced screen rearranging buffer 122 rearranges the reduced images generated through the process in step S151 in the same manner as the screen rearranging buffer 102.

The predicted image generation section 120 checks a macro block size of the macro block which is a process target in step S153, and determines whether or not the size of the macro block which is a process target is equal to or less than a predetermined threshold value (16×16 pixels) set in advance in step S154.

If it is determined that the size of the macro block which is a process target is equal to or less than 16×16 pixels, the predicted image generation section 120 controls the selection unit 123 and the selection unit 126 so as to cause the process to proceed to step S155. In this case, the selection unit 123 selects the output from the screen rearranging buffer 102, and the selection unit 126 selects the output from the selection unit 113 (the image read from the frame memory 112).

In step S155, the motion search portion 151 of the motion search and compensation unit 115 performs a motion search at integer precision using the input image and reference image with the original size which is not reduced.

In addition, in step S156, the motion search portion 151 performs a motion search at ½ precision using the input image and reference image with the original size which is not reduced. Further, in step S157, the motion search portion 151 performs a motion search at ¼ precision using the input image and reference image with the original size which is not reduced. When the process in step S157 is completed, the motion search and compensation unit 115 causes the process to proceed to step S162.

In addition, if it is determined that the size of the macro block which is a process target is larger than the predetermined threshold value (16×16 pixels) in step S154, the predicted image generation section 120 controls the selection unit 123 and the selection unit 126 so as to cause the process to proceed to step S158. In this case, the selection unit 123 selects the output from the reduced screen rearranging buffer 122, and the selection unit 126 selects the output from the reduced frame memory 125.

In step S158, the motion search portion 151 of the motion search and compensation unit 115 performs a motion search at integer precision using the input image and reference image of the reduced image which is reduced at the reduction ratio N.

In addition, in step S159, the motion search portion 151 performs a motion search at ½ precision using the input image and reference image of the reduced image which is reduced at the reduction ratio N. Further, in step S160, the motion search portion 151 performs a motion search at ¼ precision using the input image and reference image of the reduced image which is reduced at the reduction ratio N.

In step S161, the precision conversion portion 152 converts the precision of a motion vector. If the process in step S161 is completed, the motion search and compensation unit 115 causes the process to proceed to step S162.

In step S162, the motion compensation portion 153 performs motion compensation using the searched motion vector and the reference image with the original size which is not reduced, thereby generating a predicted image. A predicted image is generated as such in each mode. Among the predicted images generated, a predicted image in a mode selected as the optimal inter-prediction mode is supplied to the selection unit 116. If the inter-prediction is selected, in step S163, the motion search portion 151 outputs a variety of information such as the motion vector information so as to be supplied to the lossless coding unit 106. In addition, the motion compensation portion 153 outputs a variety of information such as the inter-prediction mode information so as to be supplied to the lossless coding unit 106. If the intra-prediction mode is selected, the process in step S163 is omitted.

When the processes to the step S163 are completed, the predicted image generation section 120 finishes the inter-motion prediction process, and causes the process to return to step S132 of FIG. 7 so as to perform the process in step S133.

[Timing Chart]

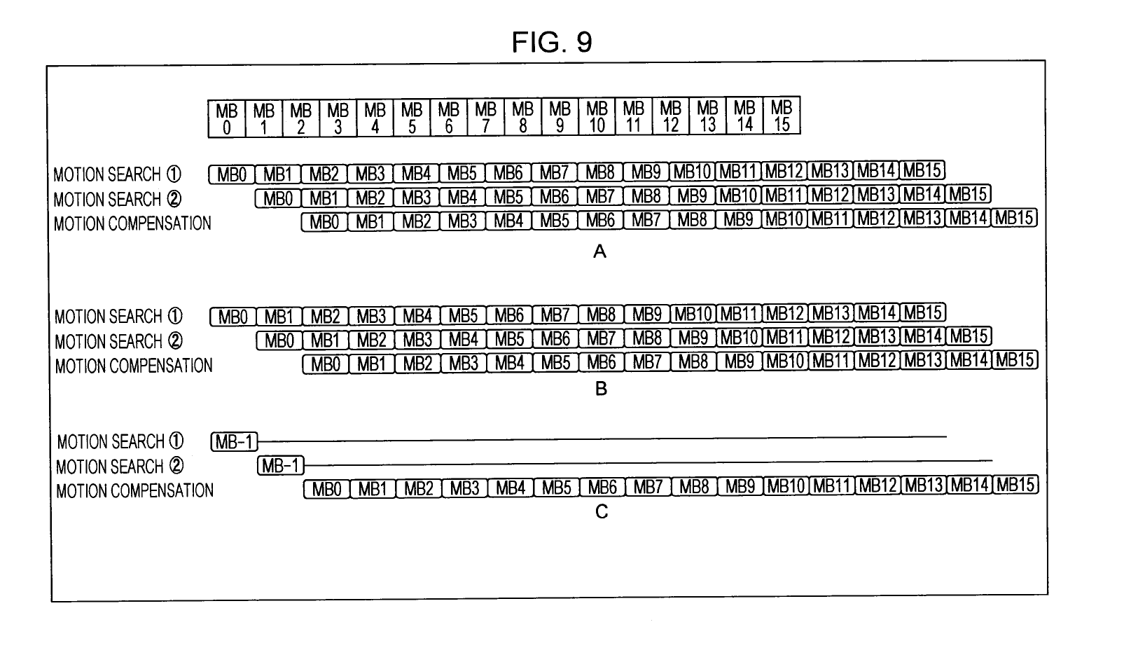

As described above, by performing each process, the motion search process and the motion compensation process are performed in procedures, for example, as shown in FIG. 9.

A of FIG. 9 shows an example of the process pipeline in AVC. In FIG. 9, the “motion search 1” indicates a motion search process at integer precision, and the “motion search 2” indicates a motion search process at sub-pixel precision. The “motion compensation” indicates a motion compensation process. Each rectangle of the right in each process of the “motion search 1”, the “motion search 2”, and the “motion compensation” indicates a process for a macro block. MB0 to MB15 indicate different macro blocks with the size of 16×16 pixels. That is to say, each rectangle of the right in each process of the “motion search 1”, the “motion search 2”, and the “motion compensation” indicates a process for each macro block.

In a case of AVC, the respective macro blocks are sequentially processed one by one as shown in A of FIG. 9.

In the image coding device 100, if a macro block which is a process target has a size of 16×16 pixels or less, as shown in B of FIG. 9, the respective macro blocks are sequentially processed in the same manner as the case of AVC (A of FIG. 9).

However, if a macro block which is a process target has a size larger than 16×16 pixels, each process in the “motion search 1” and the “motion search 2” is performed using the reduced macro block (MB-1). Therefore, each process in the “motion search 1”, the “motion search 2”, and the “motion compensation” is performed as shown in C of FIG. 9. In a case of C of FIG. 9, the motion compensation for each of MB0 to MB15 is performed by the use of a motion vector detected using MB-1.

As described above, the image coding device 100 performs a motion search using an image of a size (resolution) corresponding to the size of the partial region which is the coding process unit. For example, the image coding device 100 performs a motion search using a reduced image (an image reduced in a resolution) in an extended macro block which is a partial region which has a size larger than a predetermined size set in advance and which is the coding process unit. In this way, the image coding device 100 can improve coding efficiency while suppressing increases in a load or delay time in the coding process. In addition, by using the reduced image, a memory capacity necessary for a motion search can be decreased, and thus it is possible to suppress increases in costs or power consumption.

In addition, the coded data output from the image coding device 100 can be decoded by an image decoding device in a specification in the related art such as AVC.

[Inter-Motion Prediction Process]

In addition, in the above description, precision for performing a motion search is the same as each other in the case where the motion search is performed using an image with the original size and the case where the motion search is performed using the reduced image; however, the precision may not be the same as each other. For example, in a case of performing the motion search using the reduced image, the motion search may be performed at desired precision.

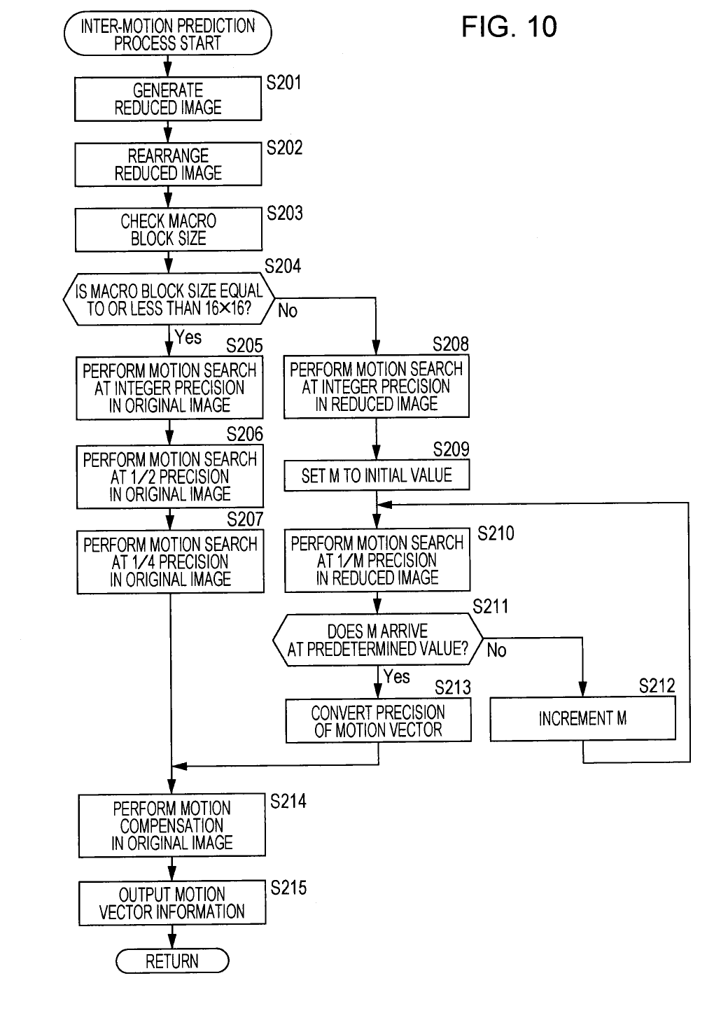

An example of the flow of the inter-motion prediction process in that case will be described with reference to the flowchart of FIG. 10. This flowchart corresponds to the flowchart of FIG. 8.

The respective processes in steps S201 to S207 of FIG. 10 are performed in the same manner as the processes in steps S151 to S157 of FIG. 8.

If it is determined that the size of the macro block which is a process target is larger than the predetermined threshold value (16×16 pixels) in step S204, the predicted image generation section 120 causes the process to proceed to step S208. In this case, the selection unit 123 selects the output from the reduced screen rearranging buffer 122, and the selection unit 126 selects the output from the reduced frame memory 125.

In step S208, the motion search portion 151 of the motion search and compensation unit 115 performs a motion search at integer precision using the input image and reference image of the reduced image which is reduced at the reduction ratio N.

In step S209, the motion search portion 151 sets a variable M to an initial value (for example, 2).

In step S210, the motion search portion 151 performs a motion search at 1/M precision in the 1/N²-reduced image. In step S211, the motion search portion 151 determines whether or not the variable M arrives at a predetermined value (m). If it is determined that a value of the variable M does not arrive at the predetermined value (m), the motion search portion 151 causes the process to proceed to step S212 so as to increment (for example, +1) the variable M, and then causes the process to return to step S210 so as to repeatedly perform the processes thereafter. That is to say, the motion search portion 151 repeatedly performs the respective processes in steps S210 to S212 until a motion search is performed at desired precision.

If it is determined that the variable M arrives at the predetermined value (m) set in advance in step S211, the precision conversion portion 152 causes the process to proceed to step S213 so as to convert the precision of the motion vector (multiplied by N). If the process in step S213 is completed, the precision conversion portion 152 causes the process to proceed to step S214.

The respective processes in steps S214 and S215 are performed in the same manner as the respective processes in steps S162 and S163 in FIG. 8.

As such, the motion search portion 151 can perform a motion search at any precision. Therefore, the image coding device 100 can suppress a decrease in the precision of a motion vector caused by performing a motion search using the reduced image.

In addition, in this case as well, the coded data output from the image coding device 100 can be decoded by an image decoding device in a specification in the related art such as AVC.

### 2. Second Embodiment

[Image Coding Device]

A value of the reduction ratio N of a reduced image used for a motion search may be plural. That is to say, a plurality of reduced images of different reduction ratios may be generated, and, among them, a motion search may be performed using a reduced image of a reduction ratio N corresponding to a macro block size.

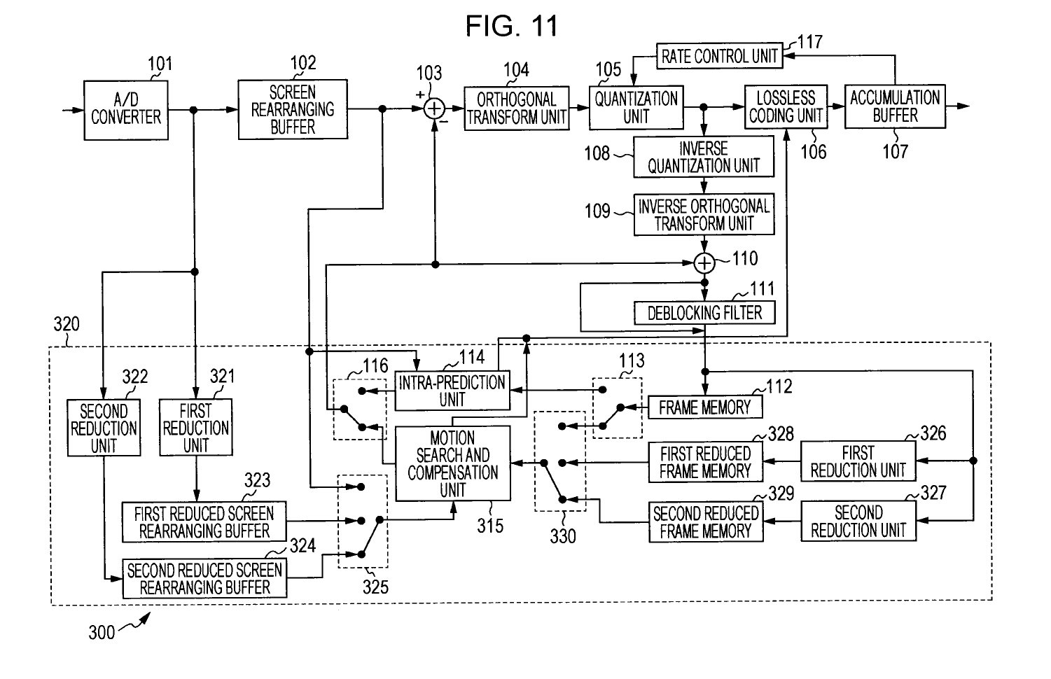

FIG. 11 is a block diagram illustrating a configuration example of the image coding device in that case. The image coding device 300 shown in FIG. 11 is basically the same device as the image coding device 100 in FIG. 2 and performs the same process, but two reduced images at different reduction ratios N.

As shown in FIG. 11, the image coding device 300 includes a predicted image generation section 320.

The predicted image generation section 320 is a processor corresponding to the predicted image generation section 120 in FIG. 2, and basically performs the same process as in the predicted image generation section 120.

However, the predicted image generation section 320 includes a motion search and compensation unit 315 instead of the motion search and compensation unit 115 of the predicted image generation section 120. In addition, the predicted image generation section 320 includes a first reduction unit 321 and a second reduction unit 322 instead of the reduction unit 121 of the predicted image generation section 120, a first reduced screen rearranging buffer 323 and a second reduced screen rearranging buffer 324 instead of the reduced screen rearranging buffer 122, and a selection unit 325 instead of the selection unit 123.

The first reduction unit 321 and the second reduction unit 322 respectively basically have the same configuration as the reduction unit 121 and reduce an input image in the same manner, but reduction ratios are different. The reduction ratios N of the two have any values as long as they are different from each other. In the following, as an example, a description will be made assuming that a reduction ratio of the first reduction unit 321 is N=4, and a reduction ratio of the second reduction unit 322 is N=2.

The first reduced screen rearranging buffer 323 and the second reduced screen rearranging buffer 324 respectively basically have the same configuration as the reduced screen rearranging buffer 122 and perform the same process. The first reduced screen rearranging buffer 323 stores a reduced image output from the first reduction unit 321. The second reduced screen rearranging buffer 324 stores a reduced image output from the second reduction unit 322.

The selection unit 325 basically has the same configuration as the selection unit 123 and performs the same process. However, the selection unit 325 selects any one of an output from the screen rearranging buffer 102, an output from the first reduced screen rearranging buffer 323, and an output from the second reduced screen rearranging buffer 324 as an input image supplied to the motion search and compensation unit 315.

For example, if a size of a macro block which is a process target is larger than a first threshold value (for example, 32×32 pixels), the selection unit 325 selects an image of the reduction ratio N=4 output from the first reduced screen rearranging buffer 323 and supplies it to the motion search and compensation unit 315 as an input image.

In addition, for example, if a size of a macro block which is a process target is equal to or less than the first threshold value (for example, 32×32 pixels) and larger than a second threshold value (for example, 16×16 pixels) which is smaller than the first threshold value, the selection unit 325 selects an image of the reduction ratio N=2 output from the second reduced screen rearranging buffer 324 and supplies it to the motion search and compensation unit 315 as an input image.

Further, for example, if a size of a macro block which is a process target is equal to or less than the second threshold value (for example, 16×16 pixels), the selection unit 325 selects an image which is not reduced and is output from the screen rearranging buffer 102 and supplies it to the motion search and compensation unit 315 as an input image.

Furthermore, the predicted image generation section 320 includes a first reduction 326 and a second reduction unit 327 instead of the reduction unit 124 of the predicted image generation section 120, a first reduced frame memory 328 and a second reduced frame memory 329 instead of the reduced frame memory 125, and a selection unit 330 instead of the selection unit 126.

The first reduction 326 and the second reduction unit 327 respectively basically have the same configuration as the reduction unit 124 and reduce an input image in the same manner, but reduction ratios thereof are different from each other. Values of the reduction ratios N of the two are respectively the same as those of the first reduction unit 321 and the second reduction unit 3322. That is to say, in a case of the example shown in FIG. 11, a reduction ratio of the first reduction 326 is N=4, and a reduction ratio of the second reduction unit 327 is N=2.

The first reduced frame memory 328 and the second reduced frame memory 329 respectively basically have the same configuration as the reduced frame memory 125 and perform the same process. The first reduced frame memory 328 stores a reduced image output from the first reduction 326. The second reduced frame memory 329 stores a reduced image output from the second reduction unit 327.

The selection unit 330 basically has the same configuration as the selection unit 126 and performs the same process. However, the selection unit 330 selects any one of an output from the frame memory 112 (the selection unit 113), an output from the first reduced frame memory 328, and an output from the second reduced frame memory 329 as a reference image supplied to the motion search and compensation unit 315.

For example, if a size of a macro block which is a process target is larger than a first threshold value (for example, 32×32 pixels), the selection unit 330 selects an image of the reduction ratio N=4 output from the first reduced frame memory 328 and supplies it to the motion search and compensation unit 315 as a reference image.

In addition, for example, if a size of a macro block which is a process target is equal to or less than the first threshold value (for example, 32×32 pixels) and larger than a second threshold value (for example, 16×16 pixels) which is smaller than the first threshold value, the selection unit 325 selects an image of the reduction ratio N=2 output from the second reduced frame memory 329 and supplies it to the motion search and compensation unit 315 as a reference image.

Further, for example, if a size of a macro block which is a process target is equal to or less than the second threshold value (for example, 16×16 pixels), the selection unit 325 selects an image which is not reduced and is output from the frame memory 112 (the selection unit 113) and supplies it to the motion search and compensation unit 315 as a reference image.

The motion search and compensation unit 315 basically has the same configuration as the motion search and compensation unit 115 and basically performs the same process. The motion search and compensation unit 315 performs a motion search process or a motion compensation process using supplied input image and reference image, and generates a predicted image through inter-prediction.

The motion search and compensation unit 315 supplies the predicted image generated to the selection unit 116, and supplies information to be transmitted, such as inter-prediction mode information or motion vector information, to the lossless coding unit 106.

[Macro Block]

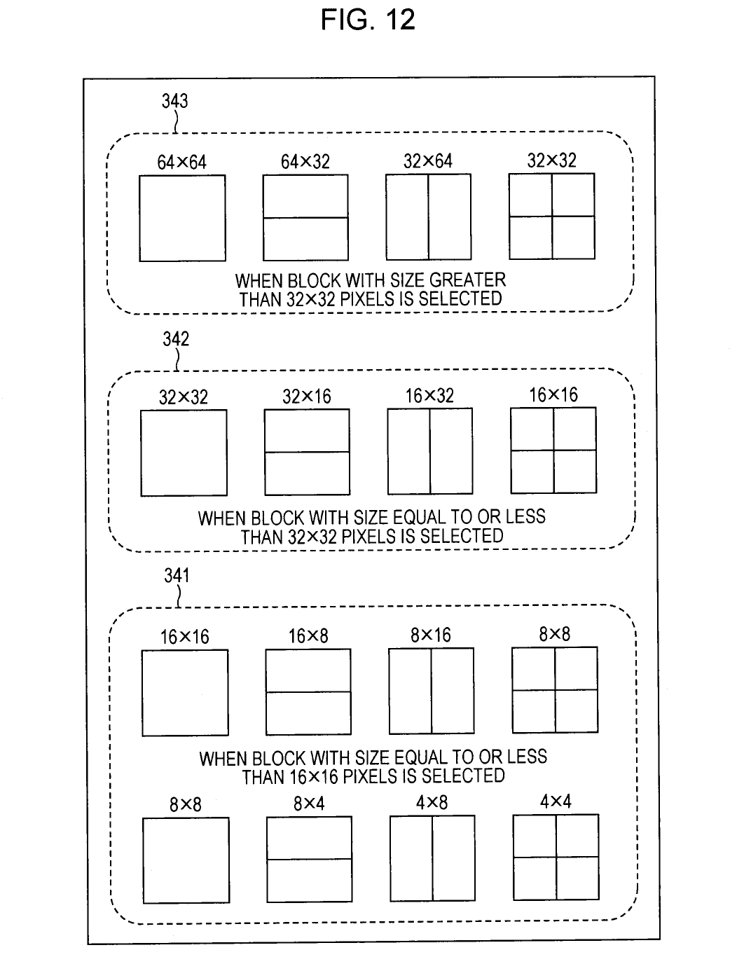

FIG. 12 shows an example of the macro block size. As shown in FIG. 12, for example, if the macro block of 16×16 pixels or less used in AVC, surrounded by the dotted line 341, is a coding process target, the motion search and compensation unit 315 performs a motion search using an image with the original size which is not reduced. In addition, for example, if the extended macro block with the size larger than 16×16 pixels and equal to or less than 32×32 pixels, surrounded by the dotted line 342, is a coding process target, the motion search and compensation unit 315 performs a motion search using a reduced image of the reduction ratio N=2.

Further, for example, if the extended macro block with the size larger than 32×32 pixels, surrounded by the dotted line 343, is a coding process target, the motion search and compensation unit 315 performs a motion search using a reduced image of the reduction ratio N=4.

[Reduction]

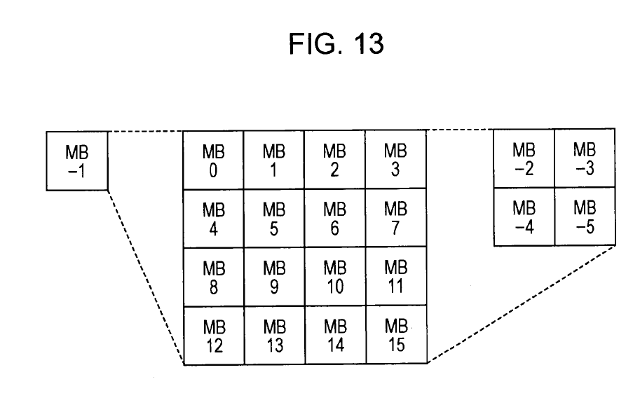

Since the reduction ratio is N=4, the first reduction unit 321 and the first reduction 326, for example, as shown in FIG. 13, generate a single macro block (MB-1) of 16×16 pixels from an extended macro block of 64×64 pixels corresponding to 4×4 macro blocks (MB0 to MB15) of 16×16 pixels.

In contrast, since the reduction ratio is N=2, the second reduction unit 322 and the second reduction unit 327, for example, as shown in FIG. 13, generate a single macro block (MB-1) of 16×16 pixels from an extended macro block of 32×32 pixels corresponding to 2×2 macro blocks (MB-2 to MB-4) of 16×16 pixels.

The motion search and compensation unit 115 performs a motion search in the macro block (MB-1). Therefore, the motion search and compensation unit 115 can perform a motion search in the extended macro block of 32×32 pixels or the extended macro block of 64×64 pixels in the same load as in a case where a motion search is performed in a single macro block of 16×16 pixels used in AVC or the like.

[Configuration of Motion Search and Compensation Unit]

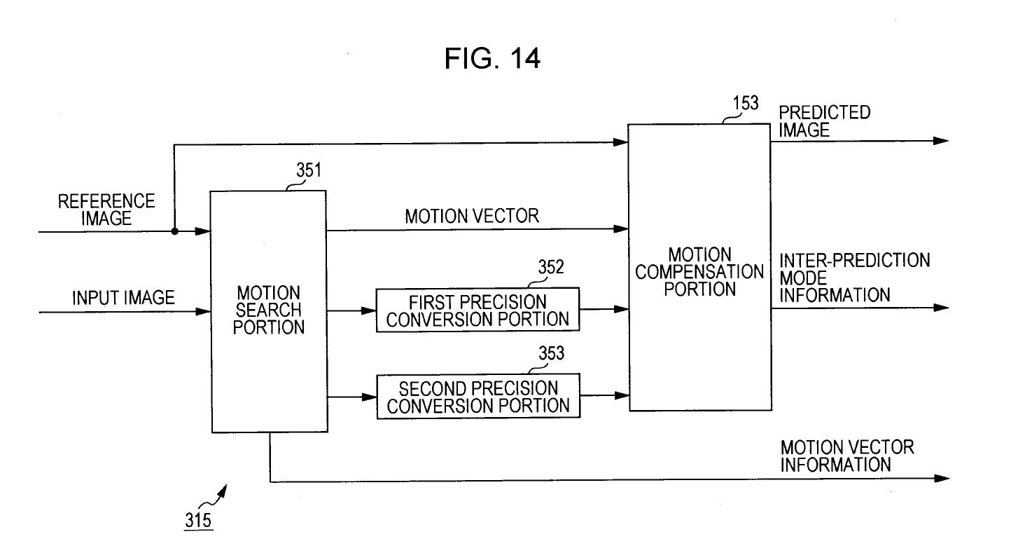

FIG. 14 is a block diagram illustrating a configuration example of the motion search and compensation unit 315 inside the image coding device 300 shown in FIG. 11. That is to say, FIG. 14 corresponds to FIG. 5.

As shown in FIG. 14, the motion search and compensation unit 315 basically has the same configuration as the motion search and compensation unit 115 but includes a motion search portion 351 instead of the motion search portion 151.

In addition, the motion search and compensation unit 315 includes a first precision conversion portion 352 and a second precision conversion portion 353 instead of the precision conversion portion 152.

The motion search portion 351 basically has the same configuration as the motion search portion 151 and performs the same process, but may perform a motion search in reduced images of a plurality of reduction ratios such as the reduction ratio N=4 and the reduction ratio N=2.

In a case where the motion search portion 351 performs a motion search using the input image or the reference image with the original size which is not reduced, a variety of parameters such as a detected motion vector are supplied to the motion compensation portion 153.

In contrast, in a case of performing a motion search using a reduced image of a first reduction ratio (reduction ratio N=4), the motion search portion 351 supplies a variety of parameters such as a detected motion vector to the first precision conversion portion 352. The first precision conversion portion 352 increases the precision of the supplied motion vector by the first reduction ratio (N=4) so as to be supplied to the motion compensation portion 153.

In addition, in a case of performing a motion search using a reduced image of a second reduction ratio (reduction ratio N=2), the motion search portion 351 supplies a variety of parameters such as a detected motion vector to the second precision conversion portion 353. The second precision conversion portion 353 increases the precision of the supplied motion vector by the second reduction ratio (N=2) so as to be supplied to the motion compensation portion 153.

The motion compensation portion 153 generates a predicted image by performing motion compensation using the parameters supplied from the motion search portion 351, the first precision conversion portion 352, or the second precision conversion portion 353, and the image with the original size which is not reduced, supplied from the selection unit 330.

The motion compensation portion 153 supplies the generated predicted image to the selection unit 116. In addition, the motion compensation portion 153 supplies the inter-prediction mode information to the lossless coding unit 106. Further, the motion search portion 151 supplies motion vector information indicating the detected motion vector to the lossless coding unit 106.

[Inter-Motion Prediction Process]

In this case, a coding process is performed in the same manner as the case of the coding process performed by the image coding device 100 described with reference to the flowchart of FIG. 6.

In addition, a prediction process is performed in the same manner as the case of the coding process performed by the image coding device 100 described with reference to the flowchart of FIG. 7.

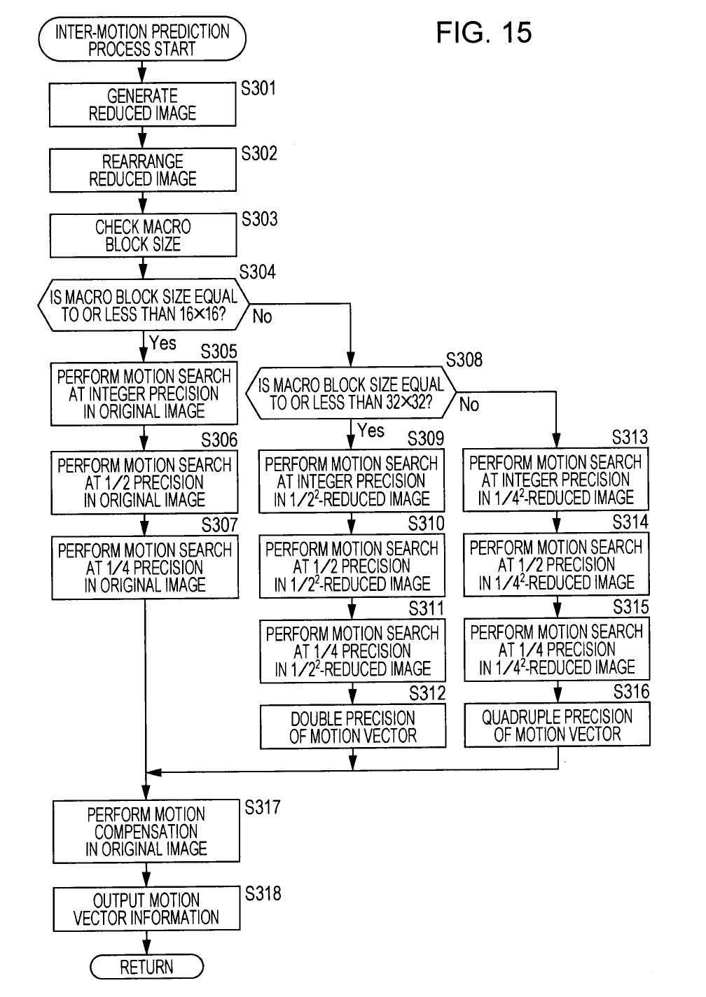

With reference to the flowchart of FIG. 15, a description will be made of an example of the flow of the inter-motion prediction process in this case. The flowchart of FIG. 15 corresponds to the flowchart of FIG. 8.

The respective processes in steps S301 to S307 are performed in the same manner as the respective processes in steps S151 to S157 of FIG. 8.

If it is determined that the size of the macro block which is a process target is larger than the second threshold value (16×16 pixels) in step S304, the predicted image generation section 320 causes the process to proceed to step S308.

In step S308, the predicted image generation section 320 determines whether or not the size of the macro block which is a process target is equal to or less than the predetermined first threshold value (32×32 pixels). If it is determined that the size of the macro block which is a process target is equal to or less than the first threshold value (32×32 pixels), the predicted image generation section 320 controls the selection unit 325 and the selection unit 330 so as to cause the process to proceed to step S309. In this case, the selection unit 325 selects the output from the second reduced screen rearranging buffer 324, and the selection unit 330 selects the output from the second reduced frame memory 329.

In step S309, the motion search portion 351 of the motion search and compensation unit 315 performs a motion search at integer precision using the input image and reference image of the reduced image (that is, a ½²-reduced image) which is reduced at the second reduction ratio (N=2).

In addition, in step S310, the motion search portion 351 performs a motion search at ½ precision using the input image and reference image of the reduced image (that is, a ½²-reduced image) which is reduced at the second reduction ratio (N=2). Further, in step S311, the motion search portion 351 performs a motion search at ¼ precision using the input image and reference image of the reduced image (that is, a ½²-reduced image) which is reduced at the second reduction ratio (N=2).

In step S312, the second precision conversion portion 353 converts the precision of the motion vector by the second reduction ratio (that is, multiplied by two). If the process in step S312 is completed, the motion search and compensation unit 315 causes the process to proceed to step S317.

If it is determined that the size of the macro block which is a process target is larger than the first threshold value (32×32 pixels) in step S308, the predicted image generation section 320 controls the selection unit 325 and the selection unit 330 so as to cause the process to proceed to step S313.

In this case, the selection unit 325 selects the output from the first reduced screen rearranging buffer 323, and the selection unit 330 selects the output from the first reduced frame memory 328.

In step S313, the motion search portion 351 of the motion search and compensation unit 315 performs a motion search at integer precision using the input image and reference image of the reduced image (that is, a ¼²-reduced image) which is reduced at the first reduction ratio (N=4).

In addition, in step S314, the motion search portion 351 performs a motion search at ½ precision using the input image and reference image of the reduced image (that is, a ¼²-reduced image) which is reduced at the first reduction ratio (N=4). Further, in step S315, the motion search portion 351 performs a motion search at ¼ precision using the input image and reference image of the reduced image (that is, a ¼²-reduced image) which is reduced at the first reduction ratio (N=4).

In step S316, the first precision conversion portion 352 converts the precision of the motion vector by the first reduction ratio (that is, multiplied by four). If the process in step S316 is completed, the motion search and compensation unit 315 causes the process to proceed to step S317.

The respective processes in steps S317 and S318 are performed in the same manner as the respective processes in steps S162 and S163.

When the processes to the step S318 are completed, the predicted image generation section 320 finishes the inter-motion prediction process, and causes the process to return to step S132 of FIG. 7 so as to perform the process in step S133.

[Timing Chart]

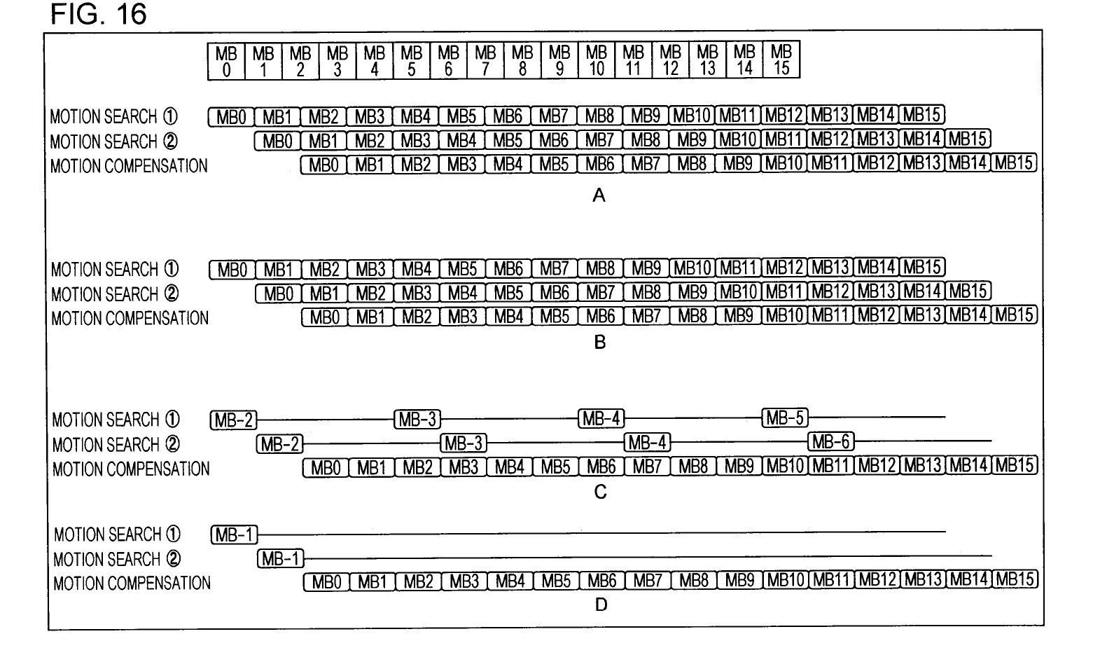

FIG. 16 shows a timing chart of a motion search process and a motion compensation process in this case. The timing chart of FIG. 16 corresponds to that of FIG. 9. A of FIG. 16 shows an example of the process pipeline in AVC in the same manner as A of FIG. 9.

In the image coding device 300, if a macro block which is a process target has a size of 16×16 pixels or less, as shown in B of FIG. 16, the respective macro blocks are sequentially processed in the same manner as the case of AVC (A of FIG. 16).

In addition, if a macro block which is a process target has a size of 32×32 pixels or less, a reduced image is used, and thus the number of motion searches is decreased as shown in C of FIG. 16. If a macro block which is a process target has a size larger than 32×32 pixels, a further reduced image is used, and thus the number of motion searches is further decreased as shown in D of FIG. 16.

Therefore, in this case as well, the image coding device 300 can improve coding efficiency while suppressing increases in a load or delay time in the coding process in the same manner as the case of the first embodiment. In addition, it is possible to suppress increases in costs or power consumption.

In addition, the coded data output from the image coding device 300 can be decoded by an image decoding device in a specification in the related art such as AVC.

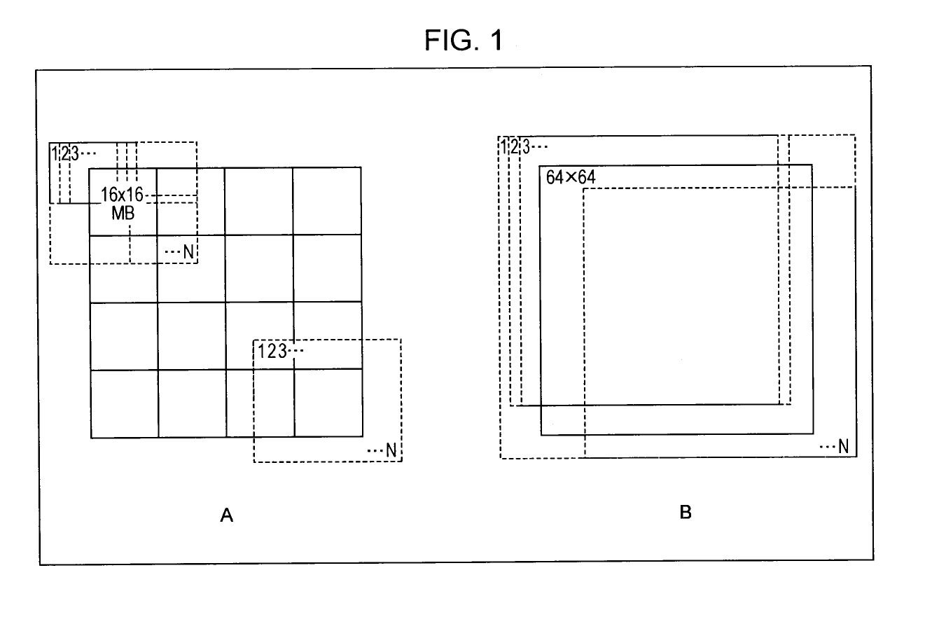

As described above, a plurality of threshold values of a macro block size are provided, and the image coding device 300 performs a motion search using an image of a size (resolution) corresponding to the macro block size according to the threshold values. In this way, the image coding device 300 can further suppress a decrease in the precision of a motion vector than the case of the image coding device 100 described with reference to FIGS. 1 to 9. In addition, the image coding device 300 can suppress increases in a load since the inter-motion prediction process can be more easily performed than in the case described with reference to FIG. 10.

### 3. Third Embodiment

[Image Coding Device]

In the above description, although a reduced image is used only in a motion search, the present invention is not limited thereto, and, in a case of an extended macro block with a size larger than a predetermined threshold value, a reduced image may be also used in motion compensation, and thus difference information of the reduced image may be coded.

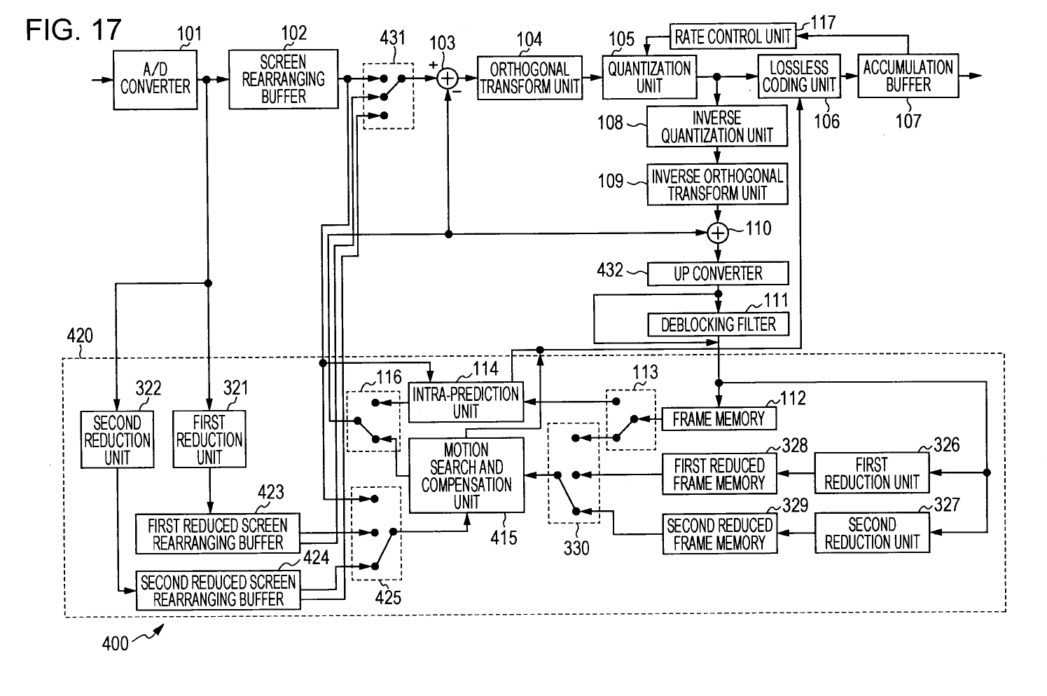

FIG. 17 is a block diagram illustrating a configuration example of the image coding device in that case.

The image coding device 400 shown in FIG. 17 basically has the same configuration as the image coding device 300 in FIG. 11 and has the same process. However, the image coding device 400 includes a predicted image generation section 420 instead of the predicted image generation section 320.

The predicted image generation section 420 basically has the same configuration as the predicted image generation section 320 and performs the same process, but includes a motion search and compensation unit 415 instead of the motion search and compensation unit 315. In addition, the predicted image generation section 420 includes a first reduced screen rearranging buffer 423 instead of the first reduced screen rearranging buffer 323, a second reduced screen rearranging buffer 424 instead of the second reduced screen rearranging buffer 324, and a selection unit 325 instead of the selection unit 425.

The first reduced screen rearranging buffer 423 basically stores an input image which is supplied from the first reduction unit 321 and is reduced at a first reduction ratio (N=4) in the same manner as the first reduced screen rearranging buffer 323. However, the first reduced screen rearranging buffer 423 supplies the reduced image to not only the selection unit 425 but also a selection unit 431. That is to say, the reduced image stored in the first reduced screen rearranging buffer 423 is used for generation of difference information as well as a motion search.

The second reduced screen rearranging buffer 424 basically stores an input image which is supplied from the second reduction unit 322 and is reduced at a second reduction ratio (N=2) in the same manner as the second reduced screen rearranging buffer 324. However, the second reduced screen rearranging buffer 424 supplies the reduced image to not only the selection unit 425 but also the selection unit 431. That is to say, the reduced image stored in the second reduced screen rearranging buffer 424 is used for generation of difference information as well as a motion search.

The selection unit 425, in the same manner as the selection unit 325, selects any one of an output from the screen rearranging buffer 102, an output from the first reduced screen rearranging buffer 423, and an output from the second reduced screen rearranging buffer 424 as an input image supplied to the motion search and compensation unit 415.

The motion search and compensation unit 415 has the same configuration as the motion search and compensation unit 315 and performs the same process. However, the motion search and compensation unit 315 uses a reduced image only for a motion search, whereas the motion search and compensation unit 415 further uses the reduced image for motion compensation. That is to say, the motion search and compensation unit 415 generates a predicted image which is reduced at a reduction ratio N. The motion search and compensation unit 415 supplies the predicted image of the reduced image to the selection unit 116.

In a case of inter-prediction for an extended macro block with a size larger than a predetermined size, the selection unit 116 selects the predicted image of the reduced image and then supplies it to the calculation unit 103 and the calculation unit 110. In other words, in this case, difference information generated by the image coding device 400 is an image which is reduced at the reduction ratio N.

The image coding device 400 further includes the selection unit 431 and an up-converter 432.

The selection unit 431 selects one of an output from the screen rearranging buffer 102, an output from the first reduced screen rearranging buffer 423, and an output from the second reduced screen rearranging buffer 424, as an image supplied to the calculation unit 103, according to a prediction mode or a size of a macro block which is a process target.

For example, if a size of a macro block which is a process target is larger than a first threshold value (32×32 pixels) in the inter-prediction mode, the selection unit 431 selects a reduced image which is output from the first reduced screen rearranging buffer 423 and is reduced at a first reduction ratio (N=4) and supplies the reduced image to the calculation unit 103. In this case, the motion search and compensation unit 415 performs a motion search and motion compensation using the reduced image which is output from the first reduced screen rearranging buffer 423 and is reduced at the first reduction ratio (N=4). Therefore, the motion search and compensation unit 415 supplies a predicted image of the reduced image which is reduced at the first reduction ratio (N=4) to the calculation unit 103 via the selection unit 116.

The calculation unit 103 subtracts the output from the motion search and compensation unit 415, from the output from the first reduced screen rearranging buffer 423, thereby generating difference information. In other words, the difference information is a reduced image which is reduced at the first reduction ratio (N=4).

In addition, for example, if a size of a macro block which is a process target is equal to or less than the first threshold value (32×32 pixels) and is larger than a second threshold value (16×16 pixels) in the inter-prediction mode, the selection unit 431 selects a reduced image which is output from the second reduced screen rearranging buffer 424 and is reduced at a second reduction ratio (N=2) and supplies the reduced image to the calculation unit 103. In this case, the motion search and compensation unit 415 performs a motion search and motion compensation using the reduced image which is output from the second reduced screen rearranging buffer 424 and is reduced at the second reduction ratio (N=2). Therefore, the motion search and compensation unit 415 supplies a predicted image of the reduced image which is reduced at the second reduction ratio (N=2) to the calculation unit 103 via the selection unit 116.

The calculation unit 103 subtracts the output from the motion search and compensation unit 415, from the output from the second reduced screen rearranging buffer 424, thereby generating difference information. In other words, the difference information is a reduced image which is reduced at the second reduction ratio (N=2).

Further, for example, if a size of a macro block which is a process target is equal to or less than the second threshold value (16×16 pixels) in the inter-prediction mode, the selection unit 431 selects an input image which is output from the screen rearranging buffer 102 and is not reduced and supplies the image to the calculation unit 103. In this case, the motion search and compensation unit 415 performs a motion search and motion compensation using the input image which is output from the screen rearranging buffer 102 and is not reduced. Therefore, the motion search and compensation unit 415 supplies a predicted image with the original size which is not reduced to the calculation unit 103 via the selection-unit 116.

The calculation unit 103 subtracts the output from the motion search and compensation unit 415, from the output from the screen rearranging buffer 102, thereby generating difference information. In other words, the difference information is an image with the original size which is not reduced.

In addition, in a case of the intra-prediction mode as well, the selection unit 431 selects an output from the screen rearranging buffer 102. In other words, difference information is generated using an image with the original size which is not reduced.

As described above, in a case where the difference information is generated using the reduced image, coded data output from the accumulation buffer 107 is generated from the difference information of the reduced image. Therefore, in this case, the image coding device 400 can decrease a bit rate of the coded data.

Since the bit rate is decreased, image quality of a decoded image is deteriorated. However, generally, in a case of using a large region such as the extended macro block as the coding process unit, a pattern of the region is simple, and motions are few. In other words, even if the bit rate of the region is decreased, an influence on image quality is comparatively small.

By using the characteristics, the image coding device 400 performs a motion search, motion compensation, and generation of difference information using a reduced image with respect to a large region with a size larger than a predetermined size such as an extended macro block, and performs a motion search, motion compensation, and generation of difference information using an image which is not reduced with respect to a small region with a size equal to or less than a predetermined size such as a macro block with a normal size, thereby suppressing deterioration in image quality and decreasing a bit rate of coded data.

In addition, when motion compensation is performed for a region with a large size such as an extended macro block, by using a reduced image, the image coding device 400 can decrease a data amount which accesses a memory (DRAM) in the motion compensation and thus can decrease a load of the motion compensation.

In addition, the image coding device 400 may provide a flag indicating difference information (that is, difference information generated using a reduced image) generated on a 1/N² resolution screen, coefficient information of a filter for generating a reduced screen, and coefficient information of a filter to an up-converter when a reduced screen returns to an original resolution, to a decoding side.

This information may be, for example, added to any position of coded data, or may be transmitted to the decoding side separately from the coded data. For example, the lossless coding unit 106 may describe the information in a bit stream as syntax. In addition, the lossless coding unit 106 may store the information in a predetermined region as subsidiary information so as to be transmitted. For example, the information may be stored in a parameter set (for example, a sequence or a header of a picture) such as SEI (Supplemental Enhancement Information).

In addition, the lossless coding unit 106 may transmit the information separately (as a separate file) from the coded data from an image coding device to an image decoding device. In this case, it is necessary to clarify a correspondence relationship between the information and the coded data (so as to be grasped in the decoding side), and any method may be used. For example, table information indicating the correspondence relationship may be created separately, or link information indicating data of a corresponding destination may be buried in mutual data.

In addition, for example, in a case where a block size and a motion search in a reduced screen are fixed and are linked, transmission of a flag indicating difference information generated on a 1/N² resolution screen may be omitted. In addition, if coefficient information of a filter for generating a reduced screen and coefficient information of a filter to an up-converter when a reduced screen returns to an original resolution are also grasped in the decoding side in advance, they are not necessarily transmitted.

Next, an image which is partially decoded will be described. In the image coding device 400, a decoded image with the original size which is not reduced is supplied to the deblocking filter 111, the frame memory 112, the first reduction 326, and the second reduction unit 327 of the predicted image generation section 420.

In other words, for example, as described above, when the difference information is generated using a reduced image, the up-converter 432 enlarges the reduced image so as to return to the original size. Any up-converter method may be used.

[Configuration of Motion Search and Compensation Unit]

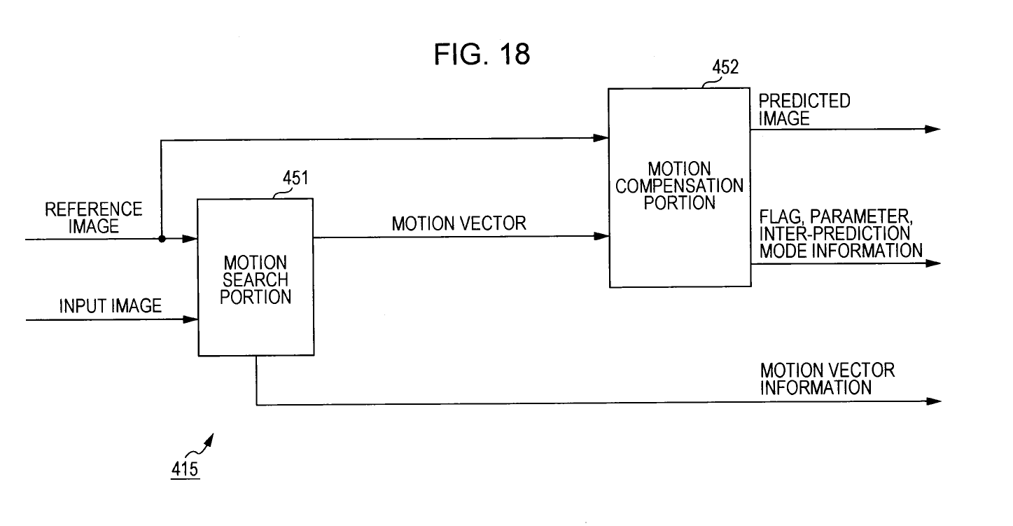

FIG. 18 is a block diagram illustrating a configuration example of the motion search and compensation unit 415 inside the image coding device 400 shown in FIG. 17.

As shown in FIG. 18, the motion search and compensation unit 415 basically has the same configuration as the motion search and compensation unit 315 and performs the same process, but also performs the motion compensation using a reduced image, and thus does not include the first precision conversion portion 352 or the second precision conversion portion 353. The motion search and compensation unit 415 includes a motion search portion 451 and a motion compensation portion 452.

The motion search portion 451 performs a motion search in the same manner as the motion search portion 351, but supplies information such as a motion vector to the motion compensation portion 452 regardless of a size of an input image or a reference image. The motion compensation portion 452 performs motion compensation using a reference image with the same size as in a motion search.

The motion compensation portion 452 supplies a generated predicted image to the selection unit 116. In addition, the motion compensation portion 452 supplies inter-prediction mode information, a flag, parameters, and the like which are to be provided to the decoding side, to the lossless coding unit 106. Further, the motion search portion 451 supplies motion vector information to the lossless coding unit 106.

[Inter-Motion Prediction Process]

Next, a flow of the process will be described. The image coding device 400 performs a coding process in the same manner as the case described with reference to the flowchart of FIG. 6. However, when the selection unit 116 selects a predicted image in step S104 of FIG. 6, the selection unit 431 selects an input image.

In addition, if the difference information is generated using the reduced image in step S105, the calculation unit 110 adds the predicted image to the decoded image in step S113, and the up-converter 432 enlarges the addition result to the original size.

The predicted image generation section 420 performs a prediction process in the same manner as the case described with reference to the flowchart of FIG. 7.

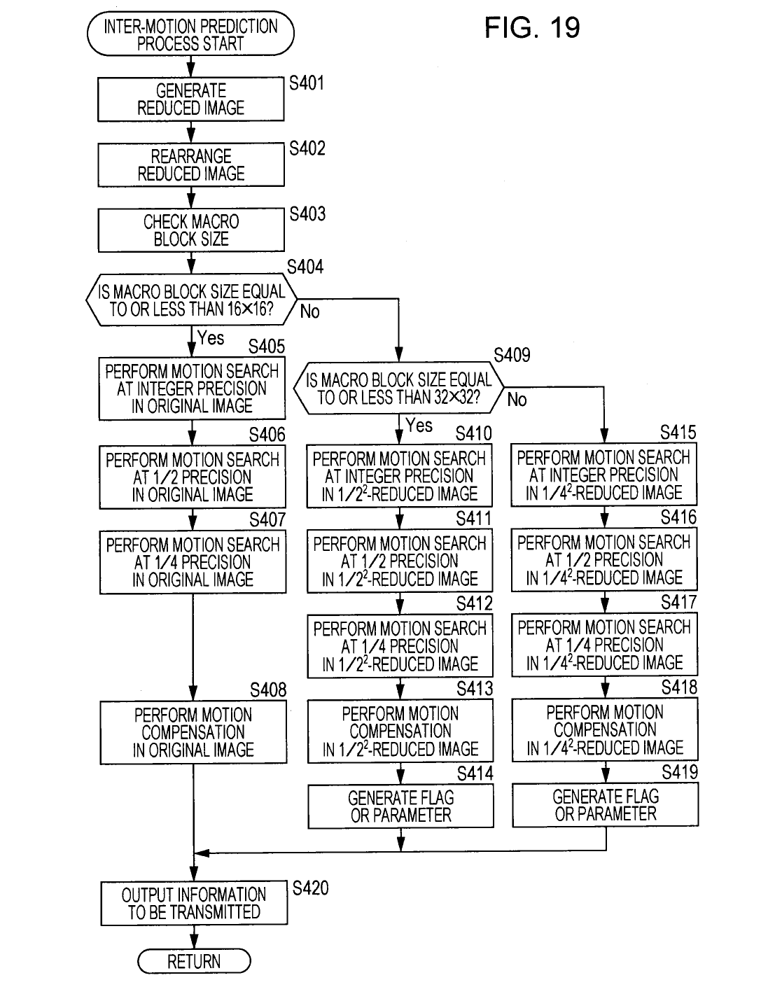

With reference to the flowchart of FIG. 19, a description will be made of an example of the flow of the inter-motion prediction process in this case. The flowchart of FIG. 19 corresponds to the flowchart of FIG. 15.

In other words, the respective processes in steps S401 to S408 are performed in the same manner as the respective processes in steps S301 to S307, and S317 in FIG. 15. If the process in step S408 is completed, the motion compensation portion 452 causes the process to proceed to step S420.

In addition, the respective processes in steps S409 to S412 of FIG. 19 are also performed in the same manner as the processes in steps S308 to S311 of FIG. 15.

The precision conversion of a motion vector is not performed as in the case of FIG. 15, and the motion compensation portion 452 of the motion search and compensation unit 415 performs motion compensation using a reference image of a reduced image (that is, ½²-reduced image) which is reduced at the second reduction ratio (N=2) in step S413. In step S414, the motion compensation portion 452 appropriately generates information to be provided to the decoding side, such as a flag or parameters. If the process in step S414 is completed, the motion compensation portion 452 causes the process to proceed to step S420.

In addition, the respective processes in steps 415 to S417 of FIG. 19 are also performed in the same manner as the processes in steps S313 to S315 of FIG. 15.

The precision conversion of a motion vector is not performed as in the case of FIG. 15, and the motion compensation portion 452 of the motion search and compensation unit 415 performs motion compensation using a reference image of a reduced image (that is, ¼²-reduced image) which is reduced at the first reduction ratio (N=4) in step S418. In step S419, the motion compensation portion 452 appropriately generates information to be provided to the decoding side, such as a flag or parameters. If the process in step S419 is completed, the motion compensation portion 452 causes the process to proceed to step S420.

In step S420, when a predicted image undergoing inter-prediction is selected as a predicted image, the motion search portion 451 and the motion compensation portion 452 of the motion search and compensation unit 415 supply information to be transmitted, such as motion vector information, inter-prediction mode information, a flag, and a variety of parameters, to the lossless coding unit 106.

If the process in step S420 is completed, the predicted image generation section 420 finishes the inter-motion prediction process, and returns the process to step S132 of FIG. 7 so as to cause the process to proceed to step S133.

As described above, in the same manner as the case of the first embodiment, the image coding device 400 performs a motion search using an image of a size (resolution) corresponding to the size of the partial region which is the coding process unit, and thus it is possible to improve coding efficiency while suppressing increases in a load or delay time in the coding process. Further, it is possible to suppress increases in costs or power consumption.

Further, in the same manner as the case of the image coding device 300, in the image coding device 400, a plurality of threshold values of a macro block size may be provided. In this way, the image coding device 400 can further suppress a decrease in the precision of a motion vector than the case of the image coding device 100 described with reference to FIGS. 1 to 9. In addition, the image coding device 400 can suppress increases in a load since the inter-motion prediction process can be more easily performed than in the case described with reference to FIG. 10.

In addition, in the image coding device 400, a single threshold value of a macro block size may be provided in the same manner as the image coding device 100. Further, as described with reference to FIG. 10, a motion search may be performed at any precision.

### 4. Fourth Embodiment

[Image Decoding Device]

The coded data output from the image coding device 400 described in the third embodiment may possibly include data obtained by coding the difference information of the reduced image, and thus it cannot be said that the data can be decoded by an image decoding device in a specification in the related art such as AVC. In order to decode the coded data generated by the image coding device 400, it is necessary to prepare an image decoding device corresponding to the image coding device 400.

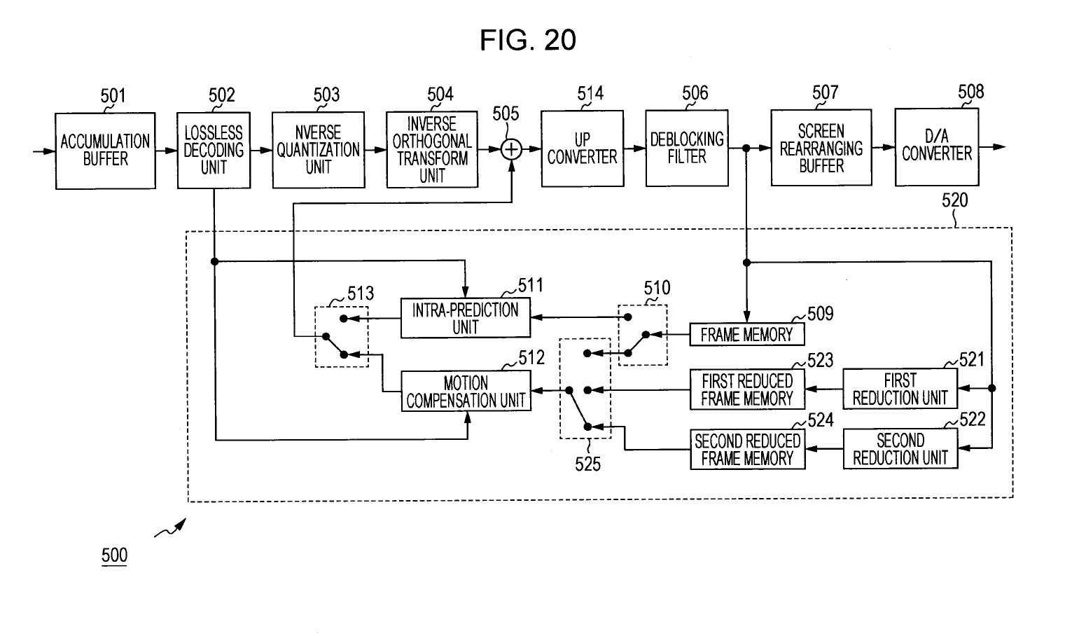

In the following, an image decoding device corresponding to the image coding device 400 described in the third embodiment will be described. FIG. 20 is a block diagram illustrating a main configuration example of the image decoding device to which the present invention is applied. The image decoding device 500 shown in FIG. 20 is a decoding device corresponding to the image coding device 400.

The coded data which is coded by the image coding device 400 is transmitted to the image decoding device 500 corresponding to the image coding device 400 via a predetermined transmission path and is then decoded.

As shown in FIG. 20, the image decoding device 500 includes an accumulation buffer 501, a lossless decoding unit 502, an inverse quantization unit 503, an inverse orthogonal transform unit 504, a calculation unit 505, a deblocking filter 506, a screen rearranging buffer 507, and a D/A converter 508. In addition, the image decoding device 500 includes a frame memory 509, a selection unit 510, an intra-prediction unit 511, a motion compensation unit 512, and a selection unit 513.

Further, the image decoding device 500 includes an up-converter 514.

The accumulation buffer 501 accumulates the coded data transmitted. The coded data is data coded by the image coding device 400. The lossless decoding unit 502 decodes the coded data which is read from the accumulation buffer 501 at a predetermined timing, using a method corresponding to the coding method of the lossless coding unit 106 of FIG. 17.

The inverse quantization unit 503 inversely quantizes coefficient data obtained by being decoded by the lossless decoding unit 502, using a method corresponding to the quantization method of the image data accumulation device 105 of FIG. 17. The inverse quantization unit 503 supplies the inversely quantized coefficient data to the inverse orthogonal transform unit 504. The inverse orthogonal transform unit 504 performs inverse orthogonal transform for the coefficient data using a method corresponding to the orthogonal transform method of the orthogonal transform unit 104 of FIG. 17, obtaining decoded remainder data corresponding to remainder data before undergoing the orthogonal transform in the image coding device 400.

The decoded remainder data obtained through the inverse orthogonal transform is supplied to the calculation unit 505. In addition, a predicted image is supplied from the intra-prediction unit 511 or the motion compensation unit 512 to the calculation unit 505 via the selection unit 513.

The calculation unit 505 adds the decoded remainder data to the predicted image, and obtains decoded image data corresponding to image data before the predicted image is subtracted by the calculation unit 103 of the image coding device 400. The calculation unit 505 supplies the decoded image data to the up-converter 514.

If the decoded image supplied from the calculation unit 505 is a reduced image, that is, the decoded image is obtained by decoding the coded data which is obtained by coding remainder information generated using a reduced image in the image coding device 400, the up-converter 514 up-converts the decoded image so as to enlarge an image of the decoded image to the original size.

The up-converter 514 supplies the decoded image with the original image size obtained through the up-converting to the deblocking filter 506. In addition, if the decoded image supplied from the calculation unit 505 is an image with the original size, the up-converter 514 omits the up-converting and supplies the decoded image to the deblocking filter 506.

The deblocking filter 506 removes block distortion from the decoded image supplied, and supplies the result to the screen rearranging buffer 507.

The screen rearranging buffer 507 rearranges images. In other words, the order of the frames changed for coding by the screen rearranging buffer 102 of FIG. 17 is changed to an order to be originally displayed. The D/A converter 508 D/A converts the image supplied from the screen rearranging buffer 507 and outputs the result to a display (not shown) so as to be displayed.

Further, the image decoding device 500 includes a first reduction unit 521, a second reduction unit 522, a first reduced frame memory 523, a second reduced frame memory 524, and a selection unit 525.

An output from the deblocking filter 506 is supplied to the frame memory 509, the first reduction unit 521, and the second reduction unit 522.

The frame memory 509, the selection unit 510, the intra-prediction unit 511, the motion compensation unit 512, and the selection unit 513 respectively correspond to the frame memory 112, the selection unit 113, the intra-prediction unit 114, the motion search and compensation unit 415, and the selection unit 116 of the image coding device 400. In addition, the first reduction unit 521, the second reduction unit 522, the first reduced frame memory 523, the second reduced frame memory 524, and the selection unit 525 respectively correspond to the first reduction 326, the second reduction unit 327, the first reduced frame memory 328, the second reduced frame memory 329, and the selection unit 330 of the image coding device 400.

The selection unit 510 reads an image which undergoes an inter-process and an image which is referred to from the frame memory 509 and supplies the images to the motion compensation unit 512. In addition, the selection unit 510 reads an image used for intra-prediction from the frame memory 509 and supplies the image to the intra-prediction unit 511.

Information or the like indicating the intra-prediction mode obtained by decoding header information is appropriately supplied to the intra-prediction unit 511 from the lossless decoding unit 502. The intra-prediction unit 511 generates a predicted image on the basis of the information and supplies the generated predicted image to the selection unit 513.

The motion compensation unit 512 acquires the information (prediction mode information, motion vector information, reference frame information, a flag, various parameters, and the like) obtained by decoding the header information from the lossless decoding unit 502.

When information indicating the inter-prediction mode is supplied, the motion compensation unit 512 controls the selection unit 525 so as to select an output from the frame memory 509, an output from the first reduced frame memory 523, or an output from the second reduced frame memory 524, designated by the flag, the various parameters, and the like supplied from the lossless decoding unit 502, and acquires the output. In addition, the motion compensation unit 512 generates a predicted image on the basis of the information supplied from the lossless decoding unit 502, and supplies the generated predicted image to the selection unit 513.

The selection unit 513 selects the predicted image generated by the motion compensation unit 512 or the intra-prediction unit 511 and supplies the image to the calculation unit 505.

The frame memory 509 to the selection unit 513, and the first reduction unit 521 to the selection unit 525 form a predicted image generation section 520. If the decoded image is a reduced image, the predicted image generation section 520 supplies a predicted image of the reduced image to the calculation unit 505, and if the decoded image is an image with the original size, it supplies a predicted image with the original size to the calculation unit 505.

[Decoding Process]

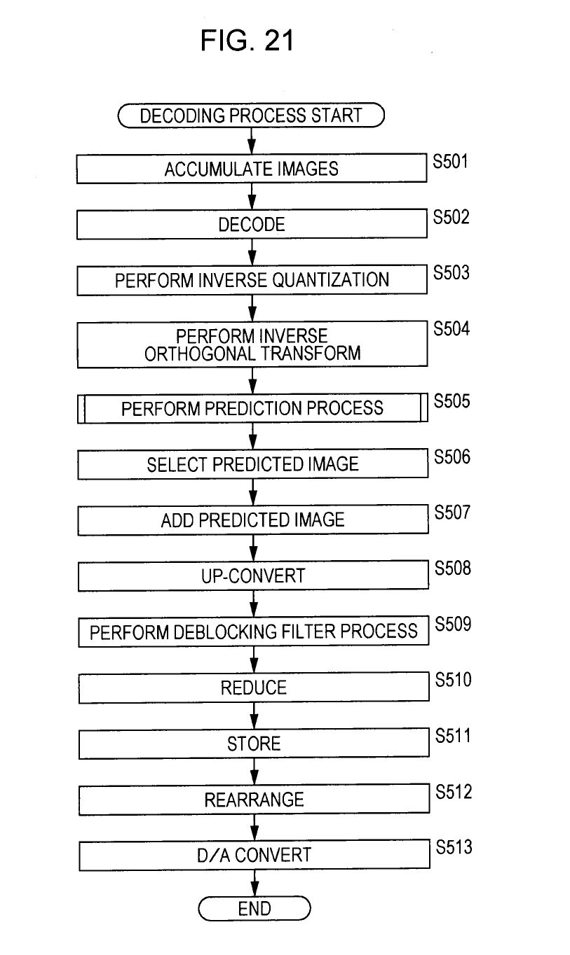

Next, a description will be made of the flow of each process executed by the image decoding device 500. First, an example of the flow of the decoding process will be described with reference to the flowchart of FIG. 21.

If the decoding process starts, in step S501, the accumulation buffer 501 accumulates the transmitted coded data. In step S502, the lossless decoding unit 502 decodes the coded data supplied from the accumulation buffer 501. In other words, the I picture, P picture, and B picture which had been coded by the lossless coding unit 106 of FIG. 17 are decoded.

At this time, the information such as the motion vector information, the reference frame information, the prediction mode information (the intra-prediction mode or the inter-prediction mode), and the flag or the parameters is also decoded.

If the prediction mode information is intra-prediction mode information, the prediction mode information is supplied to the intra-prediction unit 511. If the prediction mode information is inter-prediction mode information, motion vector information corresponding to the prediction mode information is supplied to the motion compensation unit 512.

In step S503, the inverse quantization unit 503 inversely quantizes the transform coefficients decoded by the lossless decoding unit 502 using characteristics corresponding to the characteristics of the quantization unit 105 of FIG. 17. In step S504, the inverse orthogonal transform unit 504 performs inverse orthogonal transform for the transform coefficients which has been inversely quantized by the inverse quantization unit 503 using characteristics corresponding to the corresponding to the orthogonal transform unit 104 of FIG. 17. Thereby, the difference information corresponding to the input (the output from the calculation unit 103) to the orthogonal transform unit 104 of FIG. 17 is decoded.

In step S505, the intra-prediction unit 511 or the motion compensation unit 512 performs a prediction process for each process so as to correspond to the prediction mode information supplied from the lossless decoding unit 502.

That is to say, when the intra-prediction mode information is supplied from the lossless decoding unit 502, the intra-prediction unit 511 performs an intra-prediction process in the intra-prediction mode. In addition, when the inter-prediction mode information is supplied from the lossless decoding unit 502, the motion compensation unit 512 performs a motion prediction process in the inter-prediction mode.

In step S506, the selection unit 513 selects the predicted image. That is to say, the predicted image generated by the intra-prediction unit 511 or the predicted image generated by the motion compensation unit 512 is supplied to the selection unit 513. The selection unit 513 selects the prediction unit which supplies the predicted image and supplies the predicted image to the calculation unit 505.

In step S507, the calculation unit 505 adds the predicted image selected through the process in step S506 to the difference information obtained through the process in step S504. Thereby, the original image data is decoded.

In step S508, if the decoded image supplied from the calculation unit 505 is a reduced image, the up-converter 514 up-converts the decoded image so as to be converted into the original size. In step S509, the deblocking filter 506 appropriately filters the decoded image supplied from the up-converter 514. Thereby, block distortion is appropriately removed from the decoded image.

In step S510, the first reduction unit 521 reduces the decoded image filtered at the first reduction ratio (N=4). In addition, the second reduction unit 522 reduces the decoded image filtered at the second reduction ratio (N=2).

In step S511, the frame memory 509 stores the decoded image filtered. In addition, the first reduced frame memory 523 stores a reduced image output from the first reduction unit 521. Further, the second reduced frame memory 524 stores a reduced image output from the second reduction unit 522.

In step S512, the screen rearranging buffer 507 rearranges frames of decoded image data. In other words, the order of the frames of the decoded image data changed for coding by the screen rearranging buffer 102 (FIG. 17) of the image coding device 400 is changed to an order to be originally displayed.

In step S513, the D/A converter 508 D/A converts the decoded image data of which the frames are rearranged by the screen rearranging buffer 507. The decoded image data is output to a display (not shown), and an image thereof is displayed.

[Prediction Process]

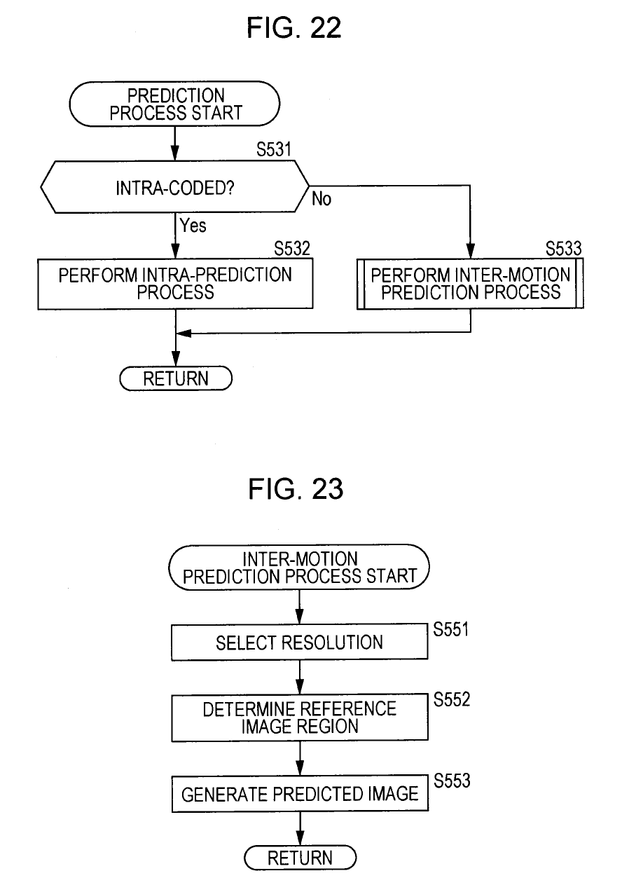

Next, referring to the flowchart of FIG. 22, an example of the flow of the prediction process executed in step S505 of FIG. 21 will be described.

If the prediction process starts, the lossless decoding unit 502 determines whether or not intra-coding is performed based on the intra-prediction mode information. If it is determined that the intra-coding is performed, the lossless decoding unit 502 supplies the intra-prediction mode information to the intra-prediction unit 511 and causes the process to proceed to step S532.

In step S532, the intra-prediction unit 511 performs an intra-prediction process. If the intra-prediction process is completed, the image decoding device 500 causes the process to return to FIG. 21 such that the processes after step S506 are performed.

In addition, if it is determined that inter-coding is performed in step S531, the lossless decoding unit 502 supplies a variety of information such as the inter-prediction mode information to the motion compensation unit 512 and causes the process to proceed to step S533.

In step S533, the motion compensation unit 512 performs an inter-motion prediction process. If the inter-motion prediction process is completed, the image decoding device 500 causes the process to return to FIG. 21 such that the processes after step S506 are performed.

[Intra-Prediction Process]

Next, with reference to FIG. 23, an example of the flow of the inter-motion prediction process executed in step S533 of FIG. 21 will be described.

If the inter-motion prediction process starts, the motion compensation unit 512 selects a resolution of a predicted image on the basis of the information supplied from the lossless decoding unit 502 in step S551. In step S552, the motion compensation unit 512 sets a position (region) of a reference image on the basis of the motion vector information. In step S553, the motion compensation unit 512 generates a predicted image. If the predicted image is generated, the inter-motion prediction process finishes. The motion compensation unit 512 causes the process to return to step S533 of FIG. 22 so as to finish the prediction process, and causes the process to proceed to step S505 of FIG. 21 such that the processes after step S506 are performed.

As above, the image decoding device 500 can decode the coded data which has been coded by the image coding device 400 on the basis of a variety of information supplied from the image coding device 400.

In other words, the image coding device 400 generates the difference information by a motion search or motion compensation using an image with a size (resolution) corresponding to a size of a partial region which is the coding process unit, and the image decoding device 500 can decode the coded data obtained by coding the difference information using a predicted image with a size (resolution) according to the size of the partial region which is the coding process unit in the same manner.

In other words, the image decoding device 500 can suppress an increase in a load of the image coding device 400 and further improve coding efficiency.

### 5. Fifth Embodiment

[Personal Computer]

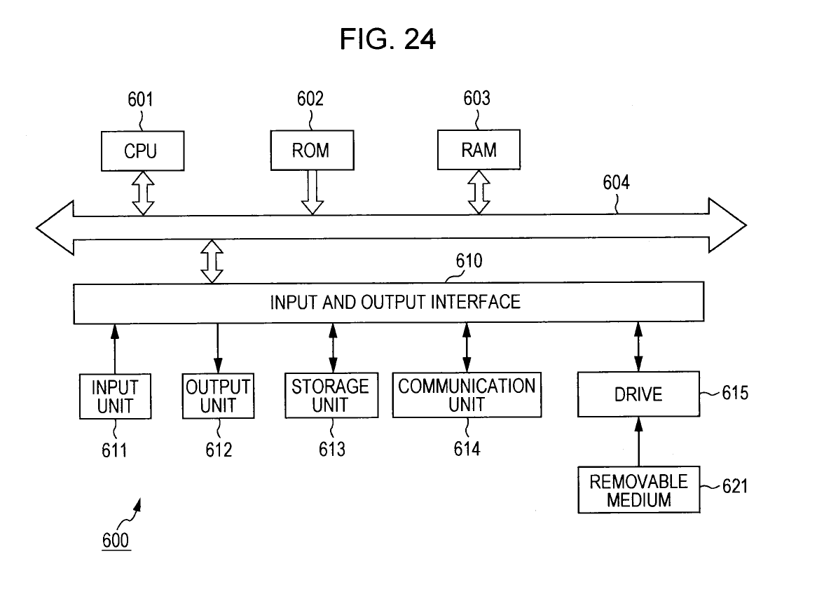

The above-described series of processes may be executed by hardware or software. In this case, for example, a personal computer as shown in FIG. 24 may be configured.

In FIG. 24, a CPU (Central Processing Unit) 601 of the personal computer 600 executes a variety of processes according to a program stored in a ROM (Read Only Memory) 602, or a program which is loaded to a RAM (Random Access Memory) 603 from a storage unit 613. The RAM 603 appropriately stores data or the like necessary for the CPU 601 to execute a variety of processes.

The CPU 601, the ROM 602, and the RAM 603 are connected to each other via a bus 604. The bus 604 is also connected to an input and output interface 610.

The input and output interface 610 is connected to an input unit 611 constituted by a keyboard, a mouse, and the like, an output unit 612 constituted by a display including a CRT (Cathode Ray Tube) or an LCD (Liquid Crystal Display), a speaker, and the like, the storage unit 613 constituted by a hard disk and the like, and a communication unit 614 constituted by a modem and the like. The communication unit 614 performs a communication process via a network including the Internet.

The input and output interface 610 is connected to a drive 615 as necessary, a removable medium 621 such as a magnetic disk, an optical disc, a magneto-optical disc, or a semiconductor memory is appropriately installed therein, and a computer program read therefrom is installed in the storage unit 613 as necessary.

In a case where the above-described series of processes is executed by software, a program constituting the software is installed from a network or a recording medium.

The recording medium is constituted not only by, for example, as shown in FIG. 24, the removable medium 621 such as a magnetic disk (including a flexible disk), an optical disc (including CD-ROM (Compact Disc-Read Only Memory) and a DVD (Digital Versatile Disc)), a magneto-optical disc (MD (Mini Disc)), or a semiconductor memory, which is distributed so as to deliver a program to a user separately from the device main body and stores the program thereon, but also by the ROM 602 or the hard disk included in the storage unit 613, which is delivered to a user in a state of being incorporated into the device main body in advance and stores a program thereon.

In addition, the program executed by the computer may be a program which performs the processes in a time series according to the order described in the present specification, or may be a program which performs the processes in parallel or at necessary timing such as being accessed.

In addition, in the present specification, steps for describing the program recorded on the recording medium does not only include processes performed in a time series according to a described order, but also include processes performed in parallel or separately even if not necessarily performed in a time series.

In addition, in the present specification, a system indicates the overall devices constituted by a plurality of devices.

In addition, in the above description, a configuration described as a single device (or a processor) may be divided so as to be configured as a plurality of devices (or processors). On the contrary, in the above description, a configuration described as a plurality of devices (processors) may be collected so as to be configured as a single device (or a processor). In addition, the above-described other configurations may be added to the configuration of each device (or each processor). In addition, a portion of the configuration of a certain device (or a processor) may be included in configurations of other devices (or other processes) as long as they are substantially the same in a configuration or an operation of the entire system. In other words, embodiments of the present invention are not limited to the above-described embodiments but are variously modified in the scope without departing from the spirit of the present invention.

For example, the above-described image coding device or the image decoding device may be applied to any electronic apparatus. Hereinafter, examples thereof will be described.

### 6. Sixth Embodiment

[Television Receiver]

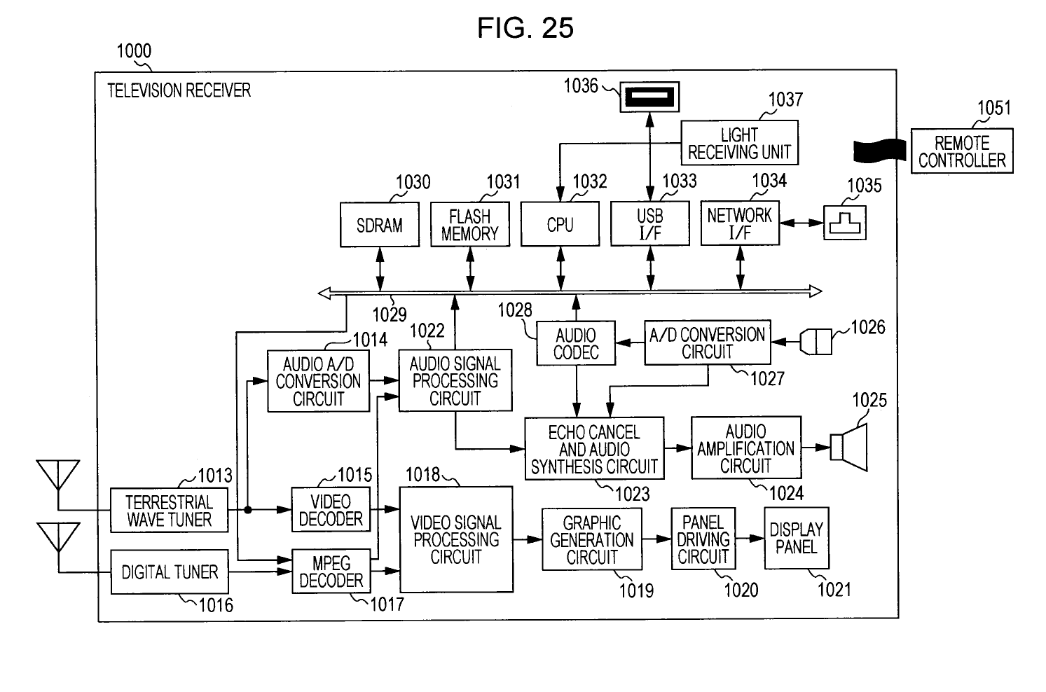

FIG. 25 is a block diagram illustrating a main configuration example of the television receiver which uses the image decoding device 500 to which the present invention is applied.

The television receiver 1000 shown in FIG. 25 includes a terrestrial wave tuner 1013, a video decoder 1015, a video signal processing circuit 1018, a graphic generation circuit 1019, a panel driving circuit 1020, and a display panel 1021.

The terrestrial wave tuner 1013 receives a broadcast wave signal of analog terrestrial broadcasting via an antenna, acquires a video signal through demodulation thereof, and supplies the video signal to the video decoder 1015. The video decoder 1015 decodes the video signal supplied from the terrestrial wave tuner 1013, and supplies the obtained digital component signal to the video signal processing circuit 1018.

The video signal processing circuit 1018 performs a predetermined process such as noise removal for the video data supplied from the video decoder 1015 and supplies the obtained video data to the graphic generation circuit 1019.

The graphic generation circuit 1019 generates video data of a program displayed on the display panel 1021, image data through a process based on an application supplied via a network, or the like, and supplies the generated video data or image data to the panel driving circuit 1020. In addition, the graphic generation circuit 1019 appropriately performs a process of generating video data (graphic) for displaying a screen which is used to select items by a user, and supplying video data obtained by superimposing it on the video data of the program to the panel driving circuit 1020.

The panel driving circuit 1020 drives the display panel 1021 on the basis of the data supplied from the graphic generation circuit 1019 and displays the video of the program or the above-described variety of screens on the display panel 1021.

The display panel 1021 includes an LCD (Liquid Crystal Display) or the like, and displays the video of the program under the control of the panel driving circuit 1020.

In addition, the television receiver 1000 includes an audio A/D (Analog/Digital) conversion circuit 1014, an audio signal processing circuit 1022, an echo cancellation and audio synthesis circuit 1023, an audio amplification circuit 1024, and a speaker 1025.

The terrestrial wave tuner 1013 acquires a video signal and an audio signal by demodulating the received broadcast wave signal. The terrestrial wave tuner 1013 supplies the acquired audio signal to the audio A/D conversion circuit 1014.

The audio A/D conversion circuit 1014 performs an A/D conversion process for the audio signal supplied from the terrestrial wave tuner 1013 and supplies the obtained digital audio signal to the audio signal processing circuit 1022.

The audio signal processing circuit 1022 performs a predetermined process such as noise removal for the audio data supplied from the audio A/D conversion circuit 1014, and supplies the obtained audio data to the echo cancellation and audio synthesis circuit 1023.

The echo cancellation and audio synthesis circuit 1023 supplies the audio data supplied from the audio signal processing circuit 1022 to the audio amplification circuit 1024.

The audio amplification circuit 1024 performs a D/A conversion process for the audio data supplied from the echo cancellation and audio synthesis circuit 1023, adjusts to a predetermined volume through an amplification process, and then outputs audio from the speaker 1025.

In addition, the television receiver 1000 includes a digital tuner 1016 and an MPEG decoder 1017.

The digital tuner 1016 receives a broadcast wave signal of digital broadcasting (digital terrestrial broadcasting, BS (Broadcasting Satellite)/CS (Communications Satellite) digital broadcasting) via the antenna, acquires an MPEG-TS (Moving Picture Experts Group-Transport Stream) through demodulation, and supplies it to the MPEG decoder 1017.

The MPEG decoder 1017 removes scramble applied to the MPEG-TS supplied from the digital tuner 1016, and extracts a stream including data of a program which is a reproducing target (viewing target). The MPEG decoder 1017 decodes audio packets forming the extracted stream, supplies the obtained audio data to the audio signal processing circuit 1022, decodes video packets forming the stream, and supplies the obtained video data to the video signal processing circuit 1018. In addition, the MPEG decoder 1017 supplies EPG (Electronic Program Guide) data extracted from the MPEG-TS to a CPU 1032 via a path (not shown).

The television receiver 1000 uses the above-described image decoding device 500 as the MPEG decoder 1017 which decodes the video packets as such. In addition, the MPEG-TS transmitted from a broadcasting station or the like is coded by the image coding device 400.

The MPEG decoder 1017 decodes the coded data of a reduced image supplied from the broadcasting station (the image coding device 400) using a predicted image of the reduced image in the same manner as the case of the image decoding device 500. Therefore, the MPEG decoder 1017 can cause the image coding device 400 to suppress an increase in a load and further improve coding efficiency.

The video data supplied from the MPEG decoder 1017 undergoes a predetermined process in the video signal processing circuit 1018 in the same manner as the case of the video data supplied from the video decoder 1015, is superimposed with generated video data in the graphic generation circuit 1019, and is supplied to the display panel 1021 via the panel driving circuit 1020, thereby displaying an image thereof.

The audio data supplied from the MPEG decoder 1017 undergoes a predetermined process in the audio signal processing circuit 1022 in the same manner as the case of the audio data supplied from the audio A/D conversion circuit 1014, is supplied to the audio amplification circuit 1024 via the echo cancellation and audio synthesis circuit 1023, and undergoes a D/A conversion process or an amplification process. As a result, audio adjusted to a predetermined volume is output from the speaker 1025.

In addition, the television receiver 1000 includes a microphone 1026 and an A/D conversion circuit 1027.

The A/D conversion circuit 1027 receives an audio signal of a user which is received by the microphone 1026 installed in the television receiver 1000 for an audio conversation, performs an A/D conversion process for the received audio signal, and supplies the obtained digital audio data to the echo cancellation and audio synthesis circuit 1023.

When audio data of a user (user A) of the television receiver 1000 is supplied from the A/D conversion circuit 1027, the echo cancellation and audio synthesis circuit 1023 performs echo cancellation for the audio data of the user A, and outputs audio data obtained through synthesis with other pieces of audio data from the speaker 1025 via the audio amplification circuit 1024.

In addition, the television receiver 1000 also includes an audio codec 1028, an internal bus 1029, an SDRAM (Synchronous Dynamic Random Access Memory) 1030, a flash memory 1031, a CPU 1032, a USB (Universal Serial Bus) I/F 1033, and a network I/F 1034.

The A/D conversion circuit 1027 receives an audio signal of a user which is received by the microphone 1026 installed in the television receiver 1000 for an audio conversation, performs an A/D conversion process for the received audio signal, and supplies the obtained digital audio data to the audio codec 1028.

The audio codec 1028 converts the audio data supplied from the A/D conversion circuit 1027 into data of a predetermined format for transmission via the network, and supplies the data to the network I/F 1034 via the internal bus 1029.

The network I/F 1034 is connected to the network via a cable installed at a network terminal 1035. The network I/F 1034 transmits the audio data supplied from the audio codec 1028, for example, to other devices connected to the network. In addition, for example, the network I/F 1034 receives audio data transmitted from the other devices connected via the network, through the network terminal 1035, and supplies the audio data to the audio codec 1028 via the internal bus 1029.

The audio codec 1028 converts the audio data supplied from the network I/F 1034 into data of a predetermined format, and supplies the data to the echo cancellation and audio synthesis circuit 1023.

The echo cancellation and audio synthesis circuit 1023 performs echo cancellation for the audio data supplied from the audio codec 1028, and outputs audio data obtained through synthesis with other pieces of audio data from the speaker 1025 via the audio amplification circuit 1024.

The SDRAM 1030 stores a variety of data necessary for the CPU 1032 to perform processes.

The flash memory 1031 stores programs executed by the CPU 1032.

The programs stored in the flash memory 1031 are read by the CPU 1032 at a predetermined timing such as the time when the television receiver 1000 is activated. The flash memory 1031 also stores EPG data acquired via digital broadcasting, data acquired from a predetermined server via the network, and the like.

For example, the flash memory 1031 stores the MPEG-TS including content data which is acquired from a predetermined server via the network under the control of the CPU 1032. The flash memory 1031 supplies the MPEG-TS to the MPEG decoder 1017 via the internal bus 1029, for example, under the control of the CPU 1032.

The MPEG decoder 1017 processes the MPEG-TS in the same manner as the case of the MPEG-TS supplied from the digital tuner 1016. As such, the television receiver 1000 receives the content data formed by video or audio via the network and can display the video or output the audio by decoding the data using the MPEG decoder 1017.

In addition, the television receiver 1000 includes a light receiving unit 1037 which receives an infrared signal transmitted from a remote controller 1051.

The light receiving unit 1037 receives infrared rays from the remote controller 1051, and outputs a control code indicating a content of a user operation obtained through demodulation to the CPU 1032.

The CPU 1032 executes the programs stored in the flash memory 1031 and controls an operation of the overall television receiver 1000 in response to the control code supplied from the light receiving unit 1037. The CPU 1032 and each unit of the television receiver 1000 are connected to each other via a path (not shown).

The USB I/F 1033 transmits and receives data to and from external apparatuses of the television receiver 1000 which are connected via a USB cable installed at a USB terminal 1036. The network I/F 1034 is connected to the network via the cable installed at the network terminal 1035, and transmits and receives data other than audio data to and from a variety of devices connected to the network.

The television receiver 1000 uses the image decoding device 500 as the MPEG decoder 1017, whereby coding efficiency of a broadcast wave signal received via the antenna or content data acquired via the network can be improved while suppressing an increase in a load, and, as a result, a real-time process can be realized at lower costs.

### 7. Seventh Embodiment

[Mobile Phone]

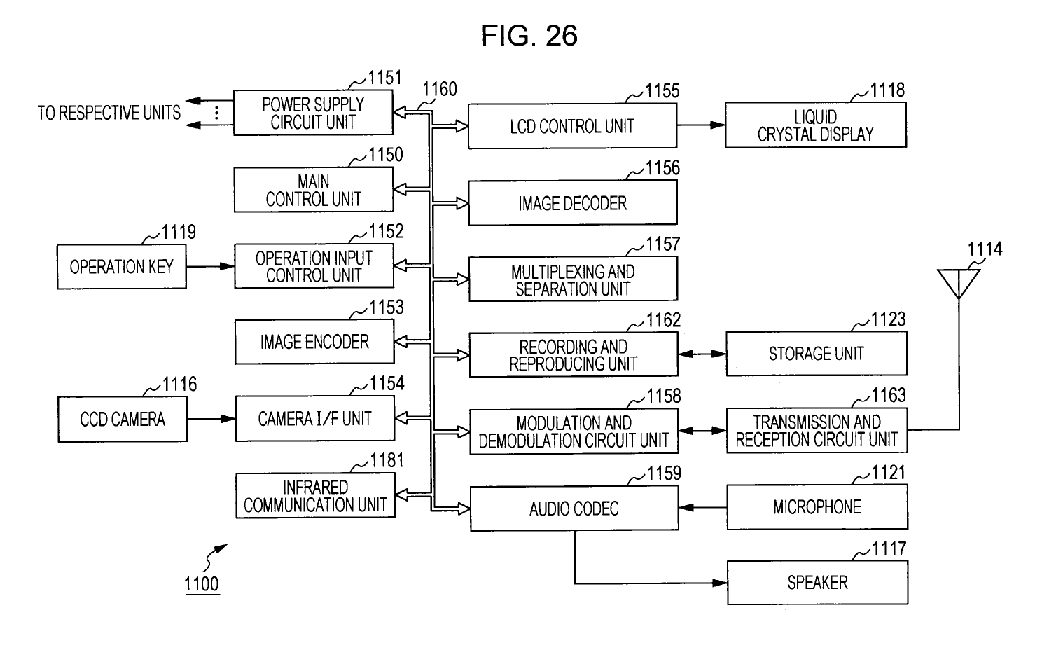

FIG. 26 is a block diagram illustrating a main configuration example of the mobile phone which uses the image coding device and the image decoding device to which the present invention is applied.

The mobile phone 1100 shown in FIG. 26 includes a main control unit 1150 which comprehensively controls the respective units, a power supply circuit unit 1151, an operation input control unit 1152, an image encoder 1153, a camera I/F unit 1154, an LCD control unit 1155, an image decoder 1156, a multiplexing and separation unit 1157, a recording and reproducing unit 1162, a modulation and demodulation unit 1158, and an audio codec 1159. They are connected to each other via a bus 1160.

In addition, the mobile phone 1100 includes an operation key 1119, a CCD (Charge Coupled Devices) camera 1116, a liquid crystal display 1118, a storage unit 1123, a transmission and reception circuit unit 1163, an antenna 1114, a microphone (mic) 1121, and a speaker 1117.

When talking finishes and a power key is turned on by an operation of a user, the power supply circuit unit 1151 activates the mobile phone 1100 to an operable state by supplying power from a battery pack to each unit.

The mobile phone 1100 performs a variety of operations such as transmission and reception of an audio signal, transmission and reception of an electronic mail or image data, image capturing, or data recording, in various modes such as a voice call mode or a data communication mode, on the basis of the control of the main control unit 1150 constituted by a CPU, a ROM, a RAM, and the like.

For example, in the voice call mode, the mobile phone 1100 converts an audio signal collected by the microphone (mic) 1121 into digital audio data using the audio codec 1159, performs a spectrum spread process for the data using the modulation and demodulation unit 1158, and performs a digital to analog conversion process and a frequency conversion process for the data using the transmission and reception circuit unit 1163. The mobile phone 1100 transmits the transmission signal through the conversion processes to a base station (not shown) via the antenna 1114. The transmission signal (audio signal) transmitted to the base station is supplied to a mobile phone of the other person on the phone via a public telephone network.

In addition, for example, in the voice call mode, the mobile phone 1100 amplifies a received signal which is received via the antenna 1114 using the transmission and reception circuit unit 1163, further performs a frequency conversion process and an analog to digital conversion process, performs an inverse spectrum spread process using the modulation and demodulation unit 1158, and converts the signal into an analog audio signal using the audio codec 1159. The mobile phone 1100 outputs the analog audio signal obtained through the conversion from the speaker 1117.

Further, for example, in a case of transmitting an electronic mail in the data communication mode, the mobile phone 1100 receives text data input through an operation of the operation key 1119 in the operation input control unit 1152. The mobile phone 1100 processes the text data in the main control unit 1150 and displays the data on the liquid crystal display 1118 as an image via the LCD control unit 1155.

In addition, the mobile phone 1100 generates electronic mail data on the basis of text data received by the operation input control unit 1152, a user's instruction, or the like, in the main control unit 1150. The mobile phone 1100 performs a spectrum spread process for the electronic mail data using the modulation and demodulation unit 1158, and performs a digital to analog conversion process and a frequency conversion process using the transmission and reception circuit unit 1163.

The mobile phone 1100 transmits the transmission signal obtained through the conversion processes to the base station (not shown) via the antenna 1114. The transmission signal (electronic mail) transmitted to the base station is supplied to a predetermined destination via the network and a mail server.

In addition, for example, in a case of receiving an electronic mail in the data communication mode, the mobile phone 1100 receives a signal transmitted from the base station using the transmission and reception circuit unit 1163 via the antenna 1114, amplifies the mail, and performs a frequency conversion process and an analog to digital conversion process. The mobile phone 1100 performs an inverse spectrum spread process for the received signal using the modulation and demodulation unit 1158 so as to restore the original electronic mail data. The mobile phone 1100 displays the restored electronic mail data on the liquid crystal display 1118 via the LCD control unit 1155.

In addition, the mobile phone 1100 may record (store) the received electronic mail data into the storage unit 1123 via the recording and reproducing unit 1162.

The storage unit 1123 is any storage medium which is rewritable. The storage unit 1123 may be, for example, a RAM, a semiconductor memory such as a built-in flash memory, may be a hard disk, or may be a removable medium such as a magnetic disk, a magneto-optical disc, an optical disc, a USB memory, or a memory card. Of course, others may be used.

In addition, for example, in a case of transmitting image data in the data communication mode, the mobile phone 1100 generates image data using CCD camera 1116 through imaging. The CCD camera 1116 includes optical devices such as a lens and a diaphragm and CCD as a photoelectric conversion device, images a subject, converts the intensity of received light into an electric signal, and generates image data of an image of the subject. The CCD camera 1116 codes the image data using the image encoder 1153 via the camera I/F unit 1154 so as to be converted into coded image data.

The mobile phone 1100 uses the above-described image coding device 100, image coding device 300, or image coding device 400 as the image encoder 1153 performing such a process. The image encoder 1153 performs a motion search using a reduced image if a macro block which is a process target is an extended macro block, in the same manner as the case of the image coding device. By coding the image data by the use of a predicted image which is generated using the reduced image, the image encoder 1153 can further improve coding efficiency while suppressing an increase in a load.

In addition, the image coding device 400 also performs motion compensation using a reduced image. Therefore, the image encoder 1153 can further improve coding efficiency by using the image coding device 400.

Further, the mobile phone 1100 analog to digital converts audio collected by the microphone (mic) 1121 at the same time as imaging using the CCD camera 1116, in the audio codec 1159, for further coding.

The mobile phone 1100 multiplexes the coded image data supplied from the image encoder 1153 and the digital audio data supplied from the audio codec 1159 using a predetermined method in the multiplexing and separation unit 1157. The mobile phone 1100 performs a spectrum spread process for the multiplexed data obtained as a result thereof using the modulation and demodulation unit 1158, and performs a digital to analog conversion process and a frequency conversion process using the transmission and reception circuit unit 1163. The mobile phone 1100 transmits the transmission signal obtained through the conversion processes to the base station (not shown) via the antenna 1114. The transmission signal (image data) transmitted to the base station is supplied to a communications partner via the network or the like.

In addition, in a case where image data is not transmitted, the mobile phone 1100 may display image data generated using the CCD camera 1116 on the liquid crystal display 1118 via the LCD control unit 1155 without using the image encoder 1153.

Further, for example, in a case where moving image file data linked to a simple home page is received in the data communication mode, the mobile phone 1100 receives a signal transmitted from the base station via the antenna 1114 using the transmission and reception circuit unit 1163, amplifies the signal, and further performs a frequency conversion process and an analog to digital conversion process. The mobile phone 1100 performs an inverse spectrum spread process for the received signal using the modulation and demodulation unit 1158 so as to restore original multiplexed data. The mobile phone 1100 separates the multiplexed data into the coded image data and the audio data in the multiplexing and separation unit 1157.

The mobile phone 1100 decodes the coded image data in the image decoder 1156 so as to generate reproduced moving image data, and displays the data on the liquid crystal display 1118 via the LCD control unit 1155. Thereby, for example, moving picture data included in a moving image file linked to a simple home page is displayed on the liquid crystal display 1118.

The mobile phone 1100 uses the above-described image decoding device 500 as the image decoder 1156 which performs such a process. In other words, the image decoder 1156 can perform inter-coding using a reduced image for coded data of difference information which is generated using a reduced image, in the same manner as the case of image decoding device 500. Therefore, the image decoder 1156 causes the image coding device 400 to further improve coding efficiency while suppressing an increase in a load.

At this time, the mobile phone 1100 converts digital audio data into an analog audio signal in the audio codec 1159 at the same time, and outputs the signal from the speaker 1117.

Thereby, for example, audio data included in a moving image file linked to a simple home page is reproduced.

In addition, the mobile phone 1100 may record (store) received data linked to a simple home page into the storage unit 1123 via the recording and reproducing unit 1162 in the same manner as the case of an electronic mail.

In addition, the mobile phone 1100 may analyze a two-dimensional code which is imaged and obtained using the CCD camera 1116 and acquire information recorded in the two-dimensional code in the main control unit 1150.

Further, the mobile phone 1100 can communicate with external apparatuses by infrared rays using an infrared communication unit 1181.

The mobile phone 1100 uses the image coding device 100, the image coding device 300, or the image coding device 400 as the image encoder 1153, thereby, for example, coding efficiency when image data generated in the CCD camera 1116 is coded and is transmitted can be improved while suppressing an increase in a load, and, as a result, a real-time process can be realized at lower costs.

In addition, the mobile phone 1100 uses the image decoding device 500 as the image decoder 1156, thereby, for example, coding efficiency of data (coded data) of a moving image file linked to a simple home page or the like can be improved while suppressing an increase in a load, and, as a result, a real-time process can be realized at lower costs.

In addition, although, in the above description, the mobile phone 1100 uses the CCD camera 1116, an image sensor (CMOS image sensor) using CMOS (Complementary Metal Oxide Semiconductor) may be used instead of the CCD camera 1116. In this case as well, the mobile phone 1100 can image a subject and generate image data of an image of the subject in the same manner as the case of using the CCD camera 1116.

In addition, although, in the above description, the mobile phone 1100 has been described, the image coding device and the image decoding device to which the present invention is applied may be applied to any apparatus as long as it has the same imaging function or communication function as the mobile phone 1100, such as, for example, PDA (Personal Digital Assistants), a smart phone, a UMPC (Ultra Mobile Personal Computer), a netbook, or a notebook personal computer, in the same manner as the case of the mobile phone 1100.

### 8. Eighth Embodiment

[Hard Disk Recorder]

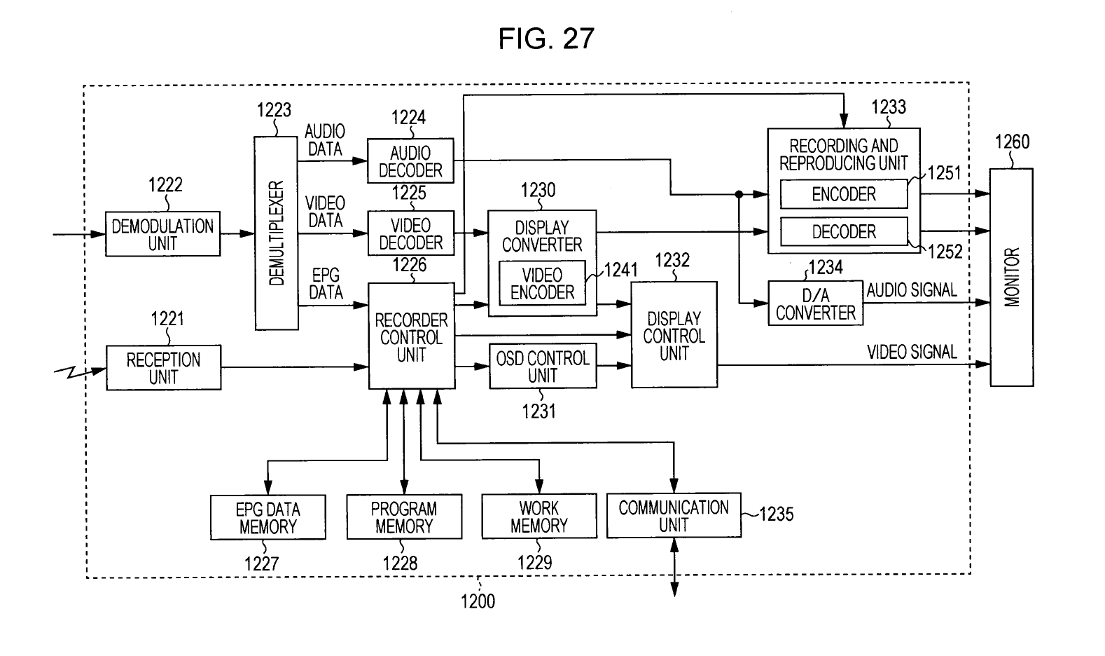

FIG. 27 is a block diagram illustrating a main configuration example of the hard disk recorder which uses the image coding device and the image decoding device to which the present invention is applied.

The hard disk recorder (HDD recorder) 1200 shown in FIG. 27 is an apparatus which reserves audio data and video data of a broadcasting program included in a broadcast wave signal (television signal), received by a turner, transmitted from a satellite or terrestrial antenna or the like in a built-in hard disk, and provides the reserved data to a user at a timing responding to an instruction from the user.

The hard disk recorder 1200 may extract, for example, audio data and video data from a broadcast wave signal and appropriately decode them so as to be stored in the built-in hard disk. In addition, for example, the hard disk recorder 1200 may acquire audio data or video data from other apparatuses via a network, and appropriately decode them so as to be stored in the built-in hard disk.

Further, for example, the hard disk recorder 1200 may decode audio data or video data recorded in the built-in hard disk so as to be supplied to a monitor 1260, and display an image thereof on a screen of the monitor 1260 and output audio thereof from a speaker of the monitor 1260. In addition, for example, the hard disk recorder 1200 may decode audio data or video data recorded extracted from a broadcast wave signal acquired via the turner or audio data or video data acquired other apparatuses via the network so as to be supplied to the monitor 1260, and display an image thereof on the screen of the monitor 1260 and output audio thereof from the speaker of the monitor 1260.

Of course, other operations are also possible.

As shown in FIG. 26, the hard disk recorder 1200 includes a reception unit 1221, a demodulation unit 1222, a demultiplexer 1223, an audio decoder 1224, a video decoder 1225, and a recorder control unit 1226. The hard disk recorder 1200 further includes an EPG data memory 1227, a program memory 1228, a work memory 1229, a display converter 1230, an OSD (On Screen Display) control unit 1231, a display control unit 1232, a recording and reproducing unit 1233, a D/A converter 1234, and a communication unit 1235.

In addition, the display converter 1230 includes a video encoder 1241. The recording and reproducing unit 1233 includes an encoder 1251 and a decoder 1252.

The reception unit 1221 receives an infrared signal from a remote controller (not shown) so as to be converted into an electric signal which is output to the recorder control unit 1226. The recorder control unit 1226 is constituted by, for example, a microprocessor and the like, and executes various processes according to programs stored in the program memory 1228. At this time, the recorder control unit 1226 uses the work memory 1229 as necessary.

The communication unit 1235 is connected to a network and communicates with other devices via the network. For example, the communication unit 1235 is controlled by the recorder control unit 1226 so as to communicate with a tuner (not shown), and mainly outputs a tuning control signal to the tuner.

The demodulation unit 1222 demodulates a signal supplied from the tuner so as to be output to the demultiplexer 1223. The demultiplexer 1223 separates the data supplied from the demodulation unit 1222 into audio data, video data, and EPG data, so as to be respectively output to the audio decoder 1224, the video decoder 1225, and the recorder control unit 1226.

The audio decoder 1224 decodes the input audio data so as to be output to the recording and reproducing unit 1233. The video decoder 1225 decodes the input video data so as to be output to the display converter 1230. The recorder control unit 1226 supplies the input EPG data to the EPG data memory 1227 so as to be stored.

The display converter 1230 encodes the video data supplied from the video decoder 1225 or the recorder control unit 1226 to, for example, video data of an NTSC (National Television Standards Committee) type using the video encoder 1241, so as to be output to the recording and reproducing unit 1233. In addition, the display converter 1230 converts a screen size of the video data supplied from the video decoder 1225 or the recorder control unit 1226 into a size corresponding to the size of the monitor 1260, converts the video data into video data of the NTSC type using the video encoder 1241 so as to be converted into an analog signal which is output to the display control unit 1232.

The display control unit 1232 superimposes an OSD signal output by the OSD (On Screen Display) control unit 1231 on the video data input from the display converter 1230 so as to be output to the display of the monitor 1260 and be displayed under the control of the recorder control unit 1226.

The audio data output by the audio decoder 1224 is converted into an analog signal by the D/A converter 1234 and is supplied to the monitor 1260. The monitor 1260 outputs the audio signal from the built-in speaker.

The recording and reproducing unit 1233 includes a hard disk as a recording medium which records video data, audio data, and the like.

For example, the recording and reproducing unit 1233 encodes the audio data supplied from the audio decoder 1224 using the encoder 1251. In addition, the recording and reproducing unit 1233 encodes the video data supplied from the video encoder 1241 of the display converter 1230 using the encoder 1251. The recording and reproducing unit 1233 synthesizes coded data of the audio data with coded data of the video data using a multiplexer. The recording and reproducing unit 1233 amplifies the synthesized data through channel coding, and writes the data in the hard disk via a recording head.

The recording and reproducing unit 1233 reproduces the data recorded in the hard disk via a reproducing head, amplifies the data, and separates the data into audio data and video data using the demultiplexer. The recording and reproducing unit 1233 decodes the audio data and the video data using the decoder 1252. The recording and reproducing unit 1233 D/A converts the decoded audio data so as to be output to the speaker of the monitor 1260. In addition, the recording and reproducing unit 1233 D/A converts the decoded video data so as to be output to the display of the monitor 1260.

The recorder control unit 1226 reads the latest EPG data from the EPG data memory 1227 on the basis of a user instruction indicated by an infrared signal from the remote controller, received via the reception unit 1221, so as to be supplied to the OSD control unit 1231. The OSD control unit 1231 generates image data corresponding to the input EPG data so as to be output to the display control unit 1232. The display control unit 1232 outputs the video data input from the OSD control unit 1231 to the display of the monitor 1260 so as to be displayed. Thereby, the EPG (Electronic Program Guide) is displayed on the display of the monitor 1260.

In addition, the hard disk recorder 1200 may acquire a variety of data such as video data, audio data, or EPG data supplied from other devices via a network such as the Internet.

The communication unit 1235 is controlled by the recorder control unit 1226 so as to acquire coded data such as video data, audio data, and EPG data transmitted from other devices via the network and to supply them to the recorder control unit 1226. For example, the recorder control unit 1226 supplies the acquired coded data of the video data or the audio data to the recording and reproducing unit 1233 so as to be stored in the hard disk. At this time, the recorder control unit 1226 and the recording and reproducing unit 1233 may perform a process such as re-encoding as necessary.

In addition, the recorder control unit 1226 decodes the acquired coded data of the video data or the audio data, and supplies the obtained video data to the display converter 1230.

The display converter 1230 processes the video data supplied from the recorder control unit 1226 in the same manner as the video data supplied from the video decoder 1225, and supplies the video data to the monitor 1260 via the display control unit 1232 such that an image thereof is displayed.

In addition, in synchronization with the display of the image, the recorder control unit 1226 may supply the decoded audio data to the monitor 1260 via the D/A converter 1234 and output audio thereof from the speaker.

Further, the recorder control unit 1226 decodes the acquired coded data of the EPG data, and supplies the decoded EPG data to the EPG data memory 1227.

The hard disk recorder 1200 as described above uses the image decoding device 500 as a decoder built in the video decoder 1225, the decoder 1252, and the recorder control unit 1226. In other words, the decoder built in the video decoder 1225, the decoder 1252, and the recorder control unit 1226 performs inter-coding for coded data which is coded using a reduced image by the image coding device 400, using a reduced image, in the same manner as the case of the image decoding device 500. Therefore, the decoder built in the video decoder 1225, the decoder 1252, and the recorder control unit 1226 can further improve coding efficiency while suppressing an increase in a load.

Therefore, for example, the hard disk recorder 1200 can improve coding efficiency of video data (coded data) received by the tuner or the communication unit 1235 or video data reproduced by the recording and reproducing unit 1233 while suppressing an increase in a load, and, as a result, a real-time process can be realized at lower costs.

In addition, the hard disk recorder 1200 uses the image coding device 100, the image coding device 300, or the image coding device 400 as the encoder 1251. Therefore, the encoder 1251 performs a motion search using a reduced image in the same manner as the case of the image coding device 100, the image coding device 300, or the image coding device 400. In this way, the encoder 1251 can further improve coding efficiency while suppressing an increase in a load.

Therefore, for example, the hard disk recorder 1200 can improve coding efficiency of coded data recorded on the hard disk while suppressing an increase in a load, and, as a result, a real-time process can be realized at lower costs.

In addition, although, in the above description, the hard disk recorder 1200 which records video data or audio data on the hard disk has been described, any recording medium may be used. For example, even in a recorder employing a recording medium other than the hard disk, such as, for example, a flash memory, an optical disc, or a video tape, the image coding device and the image decoding device to which the present invention is applied may be applied thereto, in the same manner as the case of the above-described hard disk recorder 1200.

### 9. Ninth Embodiment

[Camera]

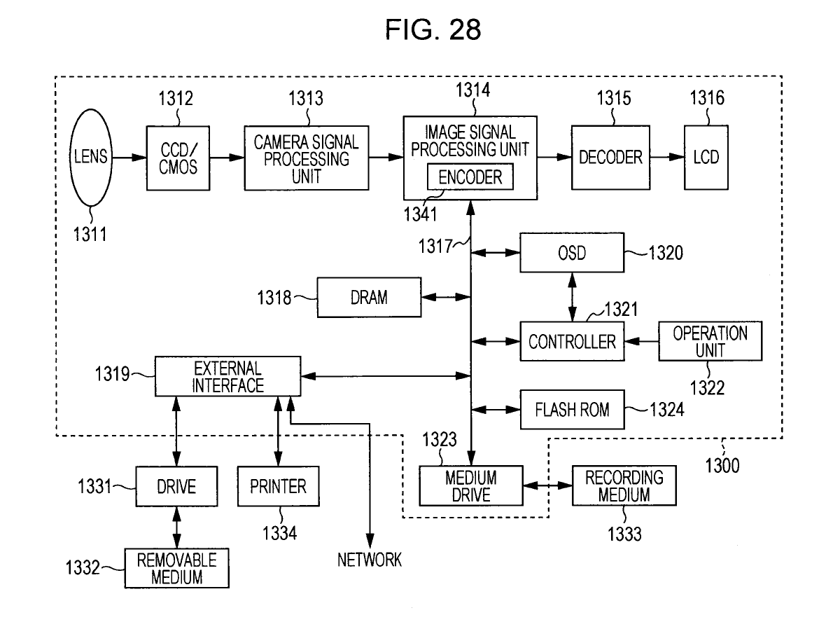

FIG. 28 is a block diagram illustrating a main configuration example of the camera which uses the image coding device and the image decoding device to which the present invention is applied.

The camera 1300 shown in FIG. 28 images a subject, and displays an image of the subject on an LCD 1316 or records the image on a recording medium 1333 as image data.

A lens block 1311 causes light (that is, an image of a subject) to be incident to CCD/CMOS 1312. The CCD/CMOS 1312 is an image sensor using CCD or CMOS, converts the intensity of the received light into an electric signal which is supplied to a camera signal processing unit 1313.

The camera signal processing unit 1313 converts the electric signal supplied from the CCD/CMOS 1312 into color difference signals of Y, Cr and Cb which are supplied to an image signal processing unit 1314. The image signal processing unit 1314 performs a predetermined image process for the image signal supplied from the camera signal processing unit 1313 or codes the image signal using an encoder 1341, under the control of a controller 1321. The image signal processing unit 1314 codes the image signal, and supplies the generated coded data to a decoder 1315. In addition, the image signal processing unit 1314 acquires display data generated in an on-screen display (OSD) 1320 and supplies the data to the decoder 1315.

In the above-described process, the camera signal processing unit 1313 appropriately uses a DRAM (Dynamic Random Access Memory) 1318 connected via a bus 1317, and holds image data or coded data obtained by coding the image data in the DRAM 1318 as necessary.

The decoder 1315 decodes the coded data supplied from the image signal processing unit 1314, and supplies the obtained image data (decoded image data) to the LCD 1316. In addition, the decoder 1315 supplies the display data supplied from the image signal processing unit 1314 to the LCD 1316. The LCD 1316 appropriately synthesizes an image of the decoded image data supplied from the decoder 1315 with an image of the display data, and displays the synthesized image.

The on-screen display 1320 outputs display data such as a menu screen or an icon constituted by symbols, characters, or figures to the image signal processing unit 1314 via the bus 1317 under the control of the controller 1321.

The controller 1321 executes various processes on the basis of a signal indicating a content commanded by a user using an operation unit 1322, and controls the image signal processing unit 1314, the DRAM 1318, an external interface 1319, the on-screen display 1320, and a medium drive 1323 via the bus 1317. Programs, data, or the like necessary for the controller 1321 to execute various processes are stored in a FLASH ROM 1324.

For example, the controller 1321 may code image data stored in the DRAM 1318 or decode coded data stored in the DRAM 1318 instead of the image signal processing unit 1314 or the decoder 1315. At this time, the controller 1321 may perform the coding and decoding processes using the same method as coding and decoding methods of the image signal processing unit 1314 and the decoder 1315, and may perform the coding and decoding processes using a method which is not treated by the image signal processing unit 1314 or the decoder 1315.

In addition, for example, in a case where starting of image printing is instructed from the operation unit 1322, the controller 1321 reads image data from the DRAM 1318, and starts printing by supplying the data to a printer 1334 connected to the external interface 1319 via the bus 1317.

Further, for example, in a case where image recording is instructed from the operation unit 1322, the controller 1321 reads coded data from the DRAM 1318, and supplies the data to the recording medium 1333 installed in the medium drive 1323 via the bus 1317 so as to be stored.

The recording medium 1333 is any removable medium which is readable and writable, such as, for example, a magnetic disk, a magneto-optical disc, an optical disc, or a semiconductor memory. Of course, any kind of recording medium 1333 may be used as a removable medium, and, a tape device, a disk, or a memory card may be used. Of course, a noncontact IC card may be used.

In addition, the medium drive 1323 and the recording medium 1333 may be integrally formed and may be constituted by a non-portable recording medium such as, for example, a built-in hard disk drive or an SSD (Solid State Drive).

The external interface 1319 is constituted by, for example, a USB input and output terminal and the like, and is connected to the printer 1334 when an image is printed. In addition, the external interface 1319 is connected to a drive 1331 as necessary, a removable medium 1332 such as a magnetic disk, an optical disc, or a magneto-optical disc is appropriately installed therein, and a computer program read therefrom is installed in the FLASH ROM 1324 as necessary.

Further, the external interface 1319 includes a network interface connected to a predetermined network such as a LAN or the Internet. For example, the controller 1321 may read coded data from the DRAM 1318 in response to an instruction from the operation unit 1322, and supply the data to other devices connected via the network from the external interface 1319. In addition, the controller 1321 may acquire coded data or image data supplied from other devices via the network using the external interface 1319, and hold the data in the DRAM 1318 or supply the data to the image signal processing unit 1314.

The above-described camera 1300 uses the image decoding device 500 as the decoder 1315. In other words, the decoder 1315 performs inter-coding using a reduced image for coded data which is supplied from the image coding device 400 and is generated using a reduced image, in the same manner as the case of the image decoding device 500. Therefore, the decoder 1315 can further improve coding efficiency while suppressing an increase in a load.

Therefore, for example, the camera 1300 can improve coding efficiency of image data generated by the CCD/CMOS 1312, coded data of video data read from the DRAM 1318 or the recording medium 1333, or coded data of video data acquired via the network, while suppressing an increase in a load, and, as a result, a real-time process can be realized at lower costs.

In addition, the camera 1300 uses the image coding device 100, the image coding device 300, or the image coding device 400 as the encoder 1341. The encoder 1341 performs a motion search using a reduced image in the same manner as the case of such an image coding device. In this way, the encoder 1341 can further improve coding efficiency while suppressing an increase in a load.

Therefore, for example, the camera 1300 can improve coding efficiency of coded data recorded the DRAM 1318 or the recording medium 1333, or coded data supplied to other devices, while suppressing an increase in a load, and, as a result, a real-time process can be realized at lower costs.

In addition, the decoding method of the image decoding device 500 may be applied to a decoding process performed by the controller 1321. Similarly, the coding methods of the image coding device 100, the image coding device 300, and the image coding device 400 may be applied to a coding process performed by the controller 1321.

In addition, image data captured by the camera 1300 may be a moving image or a still image.

Of course, the image coding device and the image decoding device to which the present invention is applied may be applied to apparatuses or systems other than the above-described apparatuses.

### REFERENCE SIGNS LIST

100: IMAGE CODING DEVICE
115: MOTION SEARCH AND COMPENSATION UNIT
121: REDUCTION UNIT
122: REDUCED SCREEN REARRANGING BUFFER
123: SELECTION UNIT
124: REDUCTION UNIT
125: REDUCED FRAME MEMORY
126: SELECTION UNIT
151: MOTION SEARCH PORTION
152: PRECISION CONVERSION PORTION
153: MOTION COMPENSATION PORTION

1-16. (canceled)

17. An image processing apparatus comprising:
resolution determining means for targeting an image which is coded for each partial region and determining a size of a resolution of an image of the partial region;
image selecting means for selecting the image of the partial region of which a resolution is converted if it is determined that the resolution of the image of the partial region is larger than a predetermined threshold value by the resolution determining means; and
motion search means for performing a motion search using the image of the partial region selected by the image selecting means.

18. The image processing apparatus according to claim 17, wherein the image selecting means selects the image of the partial region of which the resolution is not converted if it is determined that the resolution of the image of the partial region is equal to or less than the threshold value by the resolution determining means.

19. The image processing apparatus according to claim 18, wherein the threshold value is a maximum value of resolutions of a partial region regulated by an existing coding specification.

20. The image processing apparatus according to claim 18, wherein the threshold value is 16×16 pixels.

21. The image processing apparatus according to claim 18, further comprising:
a resolution converting means for converting the resolution of the image of the partial region into a plurality of resolutions,
wherein the resolution determining means determines a size of the resolution of the image of the partial region for a plurality of threshold values, and
wherein the image selecting means selects an image of the partial region used for a motion search, of the image of the partial region of the plurality of resolutions obtained by the resolution converting means converting the resolution and the image of the partial region before the resolution is converted, depending on magnitude correlation between the size of the resolution of the image of the partial region by the resolution determining means and the plurality of threshold values.

22. The image processing apparatus according to claim 18, further comprising:
precision converting means for converting precision of a motion vector detected by the motion search of the motion search means into precision in the resolution of the image of the partial region before being converted by the resolution converting means.

23. The image processing apparatus according to claim 22, further comprising:
motion compensation means for performing motion compensation using the motion vector of which precision is converted by the precision converting means and the image of the partial region before being converted by the resolution converting means, and generating a predicted image.

24. The image processing apparatus according to claim 23, further comprising:
coding means for coding the image of the partial region using the predicted image generated by the motion compensation means.

25. The image processing apparatus according to claim 18, further comprising:
motion compensation means for performing motion compensation using a motion vector detected by the motion search of the motion search means and the image of the partial region selected by the selecting means, and generating a predicted image.

26. The image processing apparatus according to claim 25, further comprising:
coding means for coding the image of the partial region using the predicted image generated by the motion compensation means.

27. The image processing apparatus according to claim 17, further comprising:
decoded image selecting means for selecting a decoded image of the partial region of which the resolution is converted if it is determined that the resolution of the image of the partial region to be coded is larger than a predetermined threshold value,
wherein the motion search means performs a motion search using the image of the partial region selected by the image selecting means as an input image and using the decoded image of the partial region selected by the decoded image selecting means as a reference image.

28. An image processing method of an image processing apparatus comprising:
causing resolution determining means to target an image which is coded for each partial region and to determine a size of a resolution of an image of the partial region;
causing image selecting means to select the image of the partial region of which a resolution is converted if it is determined that the resolution of the image of the partial region is larger than a predetermined threshold value; and
causing motion search means to perform a motion search using the selected image of the partial region.

29. An image processing apparatus comprising:
decoding means for decoding for each partial region coded data which is obtained by coding an image for each partial region;
image selecting means for selecting an image of the partial region of a resolution designated by information regarding coding of the image; and
motion compensation means for performing motion compensation using the image of the partial region selected by the image selecting means and generating a predicted image which is used for decoding the coded data by the decoding means.

30. The image processing apparatus according to claim 29, further comprising:
first resolution converting means for converting a resolution of the image of each partial region, which is obtained by the decoding means decoding coded data which is obtained by coding the image for each partial region after a resolution of the image is converted, into the resolution before the resolution is converted at the time of the decoding; and
second resolution converting means for converting the resolution of the image of the partial region of which the resolution is converted by the first resolution converting means into a resolution after the resolution is converted at the time of the coding.

31. An image processing method of an image processing apparatus comprising:
causing decoding means to decode for each partial region coded data which is obtained by coding an image for each partial region;
causing image selecting means to select an image of the partial region of a resolution designated by information regarding coding of the image; and
causing motion compensation means to perform motion compensation using the selected image of the partial region and to generate a predicted image which is used for decoding the coded data.
